(19) United States
(12) Patent Application Publication
(10) Pub. No.: US 2015/0212500 A1
(43) Pub. Date: Jul. 30, 2015

(54) DEVICE FOR CREATION OF LAYOUT INFORMATION, SYSTEM FOR OPERATION OF DOMESTIC ELECTRICAL APPLIANCES, AND SELF-PROPELLED ELECTRONIC DEVICE

(71) Applicant: Sharp Kabushiki Kaisha, Osaka-shi (JP)

(72) Inventors: Toshio Akabane, Osaka-shi (JP); Masahiro Ueda, Osaka-shi (JP); Shinji Matsuura, Osaka-shi (JP); Kazuhiro Miki, Osaka-shi (JP)

(21) Appl. No.: 14/419,719

(22) PCT Filed: Sep. 18, 2013
(86) PCT No.: PCT/JP2013/075188

§ 371 Date: Feb. 5, 2015

(30) Foreign Application Priority Data
Oct. 1, 2012 (JP) 2012-219845
Oct. 1, 2012 (JP) 2012-219847

(51) Int. Cl. G05B 15/02; H04L 12/28

(52) U.S. Cl. CPC G05B 15/02; H04L 12/2816

(57) ABSTRACT

An operation section (14) receives from a user (i) a selection instruction to select a household electric appliance as an operation target from among icons included in a layout image and (ii) an operation instruction to specify an operation content for the household electric appliance selected. A control section (21) generates, on the basis of (i) household electric appliance information stored in a setting information storage section (85) and (ii) the selection instruction and the operation instruction, an operation signal for instructing the household electric appliance selected by the user to perform the operation content specified by the user. This can improve usability for a household electric appliance operation system having a function of operating a plurality of household electric appliances.

### TECHNICAL FIELD

The present invention relates to (i) a household electric appliance operation system having a function of operating a plurality of household electric appliances and to (ii) a self-propelled electronic device.

### BACKGROUND ART

There has been known an integrated controller having a function of operating a plurality of kinds of devices.

Patent Literature 1, for example, discloses a technique of controlling the operation of a robot device with use of an integrated controller to cause the robot device to (i) move and (ii) after it has moved, operate various devices or transmit remote control signals to those various devices.

Patent Literature 2 discloses a remote monitoring system including (i) a robot cleaner including a monitoring camera for photographing a cleaning region to generate a monitoring image and a control unit for driving the robot cleaner to cause it to explore the cleaning region for preparation of a cleaning map of the cleaning region and (ii) a wireless terminal device for receiving a monitoring image and cleaning map from the robot cleaner, displaying the monitoring image and cleaning map, generating a control signal responding to an instruction entered by a user with reference to the cleaning map displayed, and transmitting the control signal to the robot cleaner. With this arrangement, the technique of Patent Literature 2 allows the user to view a cleaning map received from the robot cleaner to check, for example, a region already cleaned up and a region not yet cleaned up and select a desired position on the cleaning map to cause the robot cleaner to (i) move to that position or (ii) generate a monitoring image of that position.

### CITATION LIST

Patent Literature 1

Japanese Patent Application Publication, Tokukai, No. 2003-111157 A (Publication Date: Apr. 11, 2003)

Patent Literature 2

Japanese Patent Application Publication, Tokukai, No. 2011-233149 A (Publication Date: Nov. 17, 2011)

### SUMMARY OF INVENTION

### Technical Problem

Patent Literature 1 is unfortunately utterly silent about how a user enters an instruction into the integrated controller to operate various devices and how the integrated controller generates an operation signal to be transmitted to various devices.

The technique of Patent Literature 2 creates a cleaning map in correspondence with the history of the travel of the robot cleaner. This technique can thus only create a cleaning map of the region in which the robot cleaner has traveled, unfortunately limiting the range in which the robot cleaner can travel. Further, creating a cleaning map covering an extensive region requires driving the robot cleaner to cause it to actually travel over that entire region. Creating a cleaning map thus requires time and effort.

In addition, the technique of Patent Literature 2 causes the robot cleaner to create a cleaning map. The robot cleaner thus needs to include a position detection unit capable of detecting the position of the robot cleaner itself with high accuracy. This unfortunately increases the cost of producing the robot cleaner.

The present invention has been accomplished in view of the above problems. It is an object of the present invention to bring about improved usability for a household electric appliance operation system and a self-propelled electronic device each having a function of operating a plurality of household electric appliances.

### Solution to Problem

A household electric appliance operation system according to one mode of the present invention is a household electric appliance operation system including an operation signal transmitting section for transmitting, to a plurality of household electric appliances, an operation signal for controlling respective operations of the household electric appliances, the household electric appliance operation system including: a display section for displaying a layout image including (i) a layout outline image indicative of a shape of a region in which the operation signal transmitting section is present and (ii) at least one icon over the layout outline image which icon is of a household electric appliance present in the region; a storage section storing household electric appliance information indicative of an association, with one another, of (i) the at least one icon of the household electric appliance, (ii) one or more operation contents that the household electric appliance is capable of being instructed to perform, and (iii) operation signal information indicative of an operation signal for instructing the household electric appliance to perform an operation corresponding to the one or more operation contents; an instruction input section for receiving from a user (i) a selection instruction to select a household electric appliance as an operation target from among the at least one icon included in the layout image and (ii) an operation instruction to specify an operation content for the selected household electric appliance; and an operation signal generating section for generating the operation signal, indicated in the operation signal information, on a basis of (i) the household electric appliance information stored in the storage section and (ii) the selection instruction and the operation instruction both of which have been received by the instruction input section, the operation signal transmitting section transmitting the operation signal generated by the operation signal generating section.

### Advantageous Effects of Invention

The above household electric appliance operation system allows the user to simply (i) select an icon for the operation target from among icons included in the layout image and (ii) specify an operation content, for automatic generation and transmission of an operation signal for operating, in correspondence with the operation content specified by the user, the household electric appliance corresponding to the icon selected by the user. This can improve usability.

### BRIEF DESCRIPTION OF DRAWINGS

FIG. 1 is an explanatory diagram schematically illustrating (i) a configuration of a self-propelled electronic device (self-propelled cleaner) of an embodiment of the present invention and (ii) a configuration of an electronic device controlling system (household electric appliance operation system) of an embodiment of the present invention which electronic device controlling system includes the self-propelled electronic device.

FIG. 2 is a perspective view of the self-propelled electronic device included in the electronic device controlling system shown in FIG. 1.

FIG. 3 is a cross-sectional view of the self-propelled electronic device included in the electronic device controlling system shown in FIG. 1.

FIG. 4 is a plan view of the self-propelled electronic device included in the electronic device controlling system shown in FIG. 1, the view being taken toward a bottom surface of the self-propelled electronic device.

FIG. 5 is a perspective view illustrating a configuration of a charging station to which the self-propelled electronic device illustrated in FIGS. 2 to 4 is connected.

FIG. 6 is an explanatory diagram illustrating example images displayed by a display section of a communication terminal device included in the electronic device controlling system shown in FIG. 1.

FIG. 7 is an explanatory diagram illustrating example images displayed by the display section of the communication terminal device included in the electronic device controlling system shown in FIG. 1.

FIG. 8 is an explanatory diagram illustrating example images displayed by the display section of the communication terminal device included in the electronic device controlling system shown in FIG. 1.

FIG. 9 is an explanatory diagram illustrating example images displayed by the display section of the communication terminal device included in the electronic device controlling system shown in FIG. 1.

FIG. 10 is an explanatory diagram illustrating an example image displayed by the display section of the communication terminal device included in the electronic device controlling system shown in FIG. 1.

FIG. 11 is an explanatory diagram illustrating an example image displayed by the display section of the communication terminal device included in the electronic device controlling system shown in FIG. 1.

FIG. 12 is an explanatory diagram illustrating example images displayed by the display section of the communication terminal device included in the electronic device controlling system shown in FIG. 1.

FIG. 13 is an explanatory diagram illustrating examples of (i) icons and (ii) no-running range information associated with those icons which icons and no-running range information are stored in a server device included in the electronic device controlling system shown in FIG. 1.

FIG. 14 is an explanatory diagram illustrating examples of (i) icons and (ii) no-running range information associated with those icons which icons and no-running range information are stored in a server device included in the electronic device controlling system shown in FIG. 1.

FIG. 15 is an explanatory diagram illustrating example images displayed by the display section of the communication terminal device included in the electronic device controlling system shown in FIG. 1.

FIG. 16 is an explanatory diagram illustrating example images displayed by the display section of the communication terminal device included in the electronic device controlling system shown in FIG. 1.

FIG. 17 is an explanatory diagram illustrating example household electric appliance information stored in the server device included in the electronic device controlling system shown in FIG. 1.

FIG. 18 is a flowchart illustrating a flow of steps performed in the case where the self-propelled electronic device included in the electronic device controlling system shown in FIG. 1 is moved to a desired destination.

FIG. 19 is an explanatory diagram illustrating example images displayed by the display section of the communication terminal device included in the electronic device controlling system shown in FIG. 1.

FIG. 20 is an explanatory diagram illustrating example images displayed by the display section of the communication terminal device included in the electronic device controlling system shown in FIG. 1.

FIG. 21 is an explanatory diagram illustrating example images displayed by the display section of the communication terminal device included in the electronic device controlling system shown in FIG. 1.

FIG. 22 is an explanatory diagram illustrating a structure of layout information for use in the electronic device controlling system shown in FIG. 1.

### DESCRIPTION OF EMBODIMENTS

The following description will discuss an embodiment of the present invention.

(1-1. Overall Configuration of Electronic Device Control System 100)

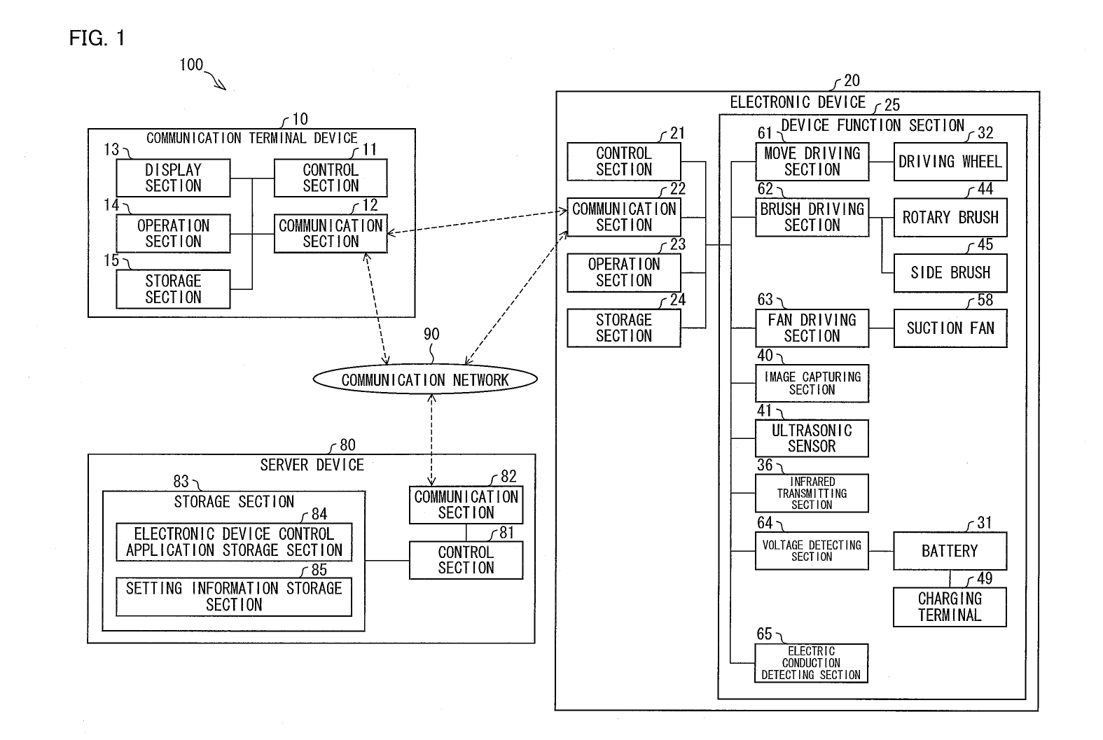

FIG. 1 is an explanatory diagram schematically illustrating a configuration of an electronic device controlling system (household electric appliance operation system) 100 of the present embodiment. As illustrated in FIG. 1, the electronic device controlling system 100 includes a communication terminal device 10, a self-propelled electronic device 20, and a server device (layout information creating device) 80. The communication terminal device 10, the self-propelled electronic device 20, and the server device 80 are connected to one another so as to be communicable with one another via a communication network 90. The communication terminal device 10 and the self-propelled electronic device 20 have respective functions of communicating with each other without the communication network 90. Note that the number of self-propelled electronic devices 20 included in the electronic device controlling system 100 is not limited to one. The electronic device controlling system 100 may include a plurality of self-propelled electronic devices 20. Similarly, the number of communication terminal devices 10 included in the electronic device controlling system 100 is neither limited to one. The electronic device controlling system 100 may include a plurality of communication terminal devices 10.

(1-1-1. Configuration of Communication Terminal Device 10)

As illustrated in FIG. 1, the communication terminal device 10 includes a control section 11, a communication section 12, a display section 13, an operation section 14, and a storage section 15. Note that the configuration of the communication terminal device 10 is not particularly limited provided that the communication terminal device 10 is a communication terminal device having functions of the respective sections. Examples of the communication terminal device 10 include a smart phone, a tablet terminal, a mobile phone, a PDA (Personal Digital Assistance), a personal computer, and a portable game machine.

The control section 11 is control means for controlling operations of the sections of the communication terminal device 10. The control section 11 is constituted by a computer device that includes (i) a computation section such as a CPU or a dedicated-purpose processor and (ii) a memory such as a RAM (Random Access Memory), a ROM (Read Only Memory) or an HDD (Hard Disk Drive) (none of which is illustrated in FIG. 1). The control section 11 controls the operations of the sections of the communication terminal device 10 by (i) reading, from the storage section, various pieces of information and programs for executing various controls and (ii) executing those programs.

The communication section 12 is communication means having (i) a function of communicating with a remote device via the communication network 90 (long-distance communication function; for example, a communication function in an outside mode described below) and (ii) a function of communicating with a device present in a communicable range (e.g., inside a facility where the communication terminal device 10 and the device are present) (short-distance communication function; for example, a communication function in a house mode described below).

Examples of the communication network 90 via which the communication section 12 performs the long-distance communication function include the Internet, telephone line network, mobile communications network, CATV communications network, and satellite communications network.

Examples of the short-distance communication function include (i) a communication function of a Wi-Fi (registered trademark) device which mutually connects wireless devices with use of a wireless LAN standard, i.e., IEEE802.11 (IEEE802.11a or IEEE802.11b), (ii) a communication function based on a wireless LAN standard other than IEEE802.11, (iii) a communication function based on a short-distance wireless communication standard such as Bluetooth (registered trademark) or ZigBee (registered trademark) and (iv) an infrared communication function. Note that the communication network for use in the present invention allows both the long-distance communication function and the short-distance communication function to be performed.

The display section 13 displays, in response to an instruction from the control section 11, various pieces of information to be given to a user. The configuration of the display section 13 is not particularly limited. Examples of the display section 13 include a liquid crystal display panel, an organic EL panel, and a plasma display panel.

The operation section 14 receives an operation entered by a user and notifies the control section 11 of the operation. The configuration of the operation section 14 is not particularly limited. Various conventionally publicly-known operation entering means can be employed. Note that the present embodiment employs a touch panel which serves as the display section 13 and the operation section 14.

The storage section 15 is storage means for storing various pieces of information used by the communication terminal device 10. The configuration of the storage section 15 is not particularly limited. Conventionally publicly-known storage means can be employed.

(1-1-2. Configuration of Self-Propelled Electronic Device 20)

The self-propelled electronic device 20 is a household electric appliance having a function of performing (i) an operation responding to an instruction given by a user to an operation section (that is, an operation section 23 described below) included in the self-propelled electronic device 20 itself and (ii) an operation responding to a control command from the communication terminal device 10. The description of the present embodiment deals with the self-propelled electronic device 20 mainly as a self-propelled cleaner. However, the self-propelled electronic device 20 is not limited to a self-propelled cleaner. The self-propelled electronic device 20 simply needs to be a self-propelled electronic device having a function of performing an operation responding to a control command from the communication terminal device 10 (that is, an electronic device having a moving function). The self-propelled electronic device 20 may be, for example, an air cleaning device, an image capturing device, an AV device, or any of various robot devices (for example, a housework assistance robot or animal-shaped robot).

As illustrated in FIG. 1, the self-propelled electronic device 20 includes a control section 21, a communication section 22, the operation section 23, a storage section 24, and a device function section 25.

The control section 21 is control means for controlling operations of the sections of the self-propelled electronic device 20. The control section 21 is constituted by a computer device that includes (i) a computation section such as a CPU or a dedicated-purpose processor and (ii) a memory such as a RAM, a ROM or an HDD (none of which is illustrated in FIG. 1). The control section 21 controls the operations of the sections of the self-propelled electronic device 20 by (i) reading, from the storage section, various pieces of information and programs for executing various controls and (ii) executing those programs.

The communication section 22 is communication means having (i) a function of communicating with a remote device via the communication network 90 (long-distance communication function) and (ii) a function of communicating with a device present in a communicable range (e.g., inside a facility where the self-propelled electronic device 20 and the device are present) (short-distance communication function). A communication section similar to the communication section 12 included in the communication terminal 10 can be employed as the communication section 22.

The operation section 23 receives an instruction entered by a user and notifies the control section 21 of the instruction. The configuration of the operation section 23 is not particularly limited. The operation section 23 may be constituted by key operation buttons, a touch panel, or a combination of the key operation buttons and the touch panel.

The storage section 24 is storage means for storing various pieces of information used by the self-propelled electronic device 20. The configuration of the storage section 24 is not particularly limited. Various RAMs, ROMs, and HDDs can be employed as the storage section 24.

The device function section 25 performs a device function of the self-propelled electronic device 20 in response to an instruction from the control section 21. In the case where the self-propelled electronic device 20 is, for example, a self-propelled cleaner, the device function section 25 performs such functions as a running function (moving function), a cleaning function (dust collecting function), and an image capturing function. In the case where the self-propelled electronic device 20 is, for example, an air cleaning device, an image capturing device, an AV device, or any of various robots, the device function section 25 performs a device function of that device (for example, a running function, an air cleaning function, a photography function, or a moving function).

In the present embodiment, the self-propelled electronic device 20 is a self-propelled cleaner, and the device function section 25 includes, as illustrated in FIG. 1, a move driving section 61, a brush driving section 62, a fan driving section 63, an image capturing section 40, driving wheels 32, a rotary brush 44, side brushes 45, a suction fan 58, an ultrasonic sensor 41, an infrared transmitting section 36, a voltage detecting section 64, a battery 31, charging terminals 49, and an electric conduction detecting section 65.

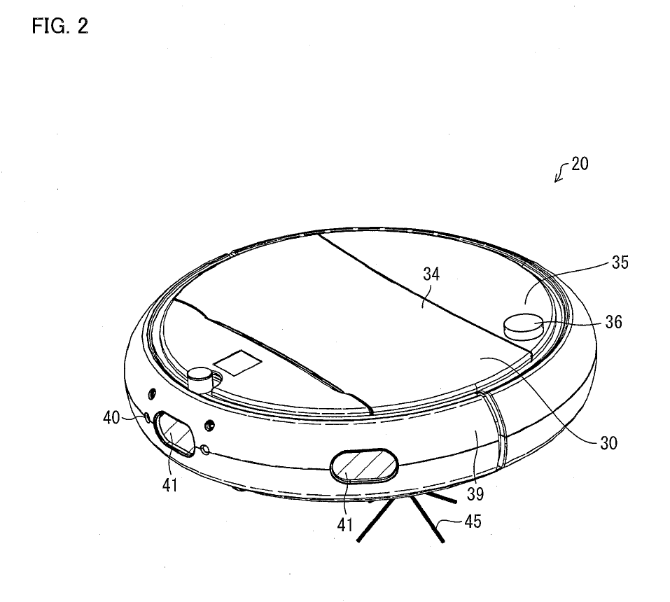

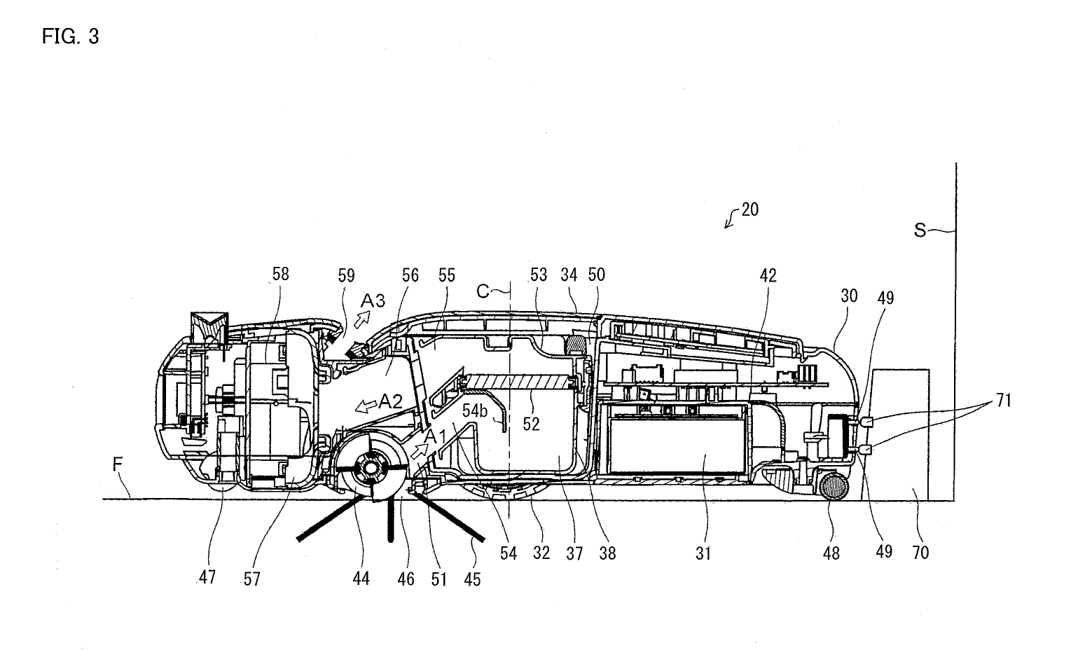

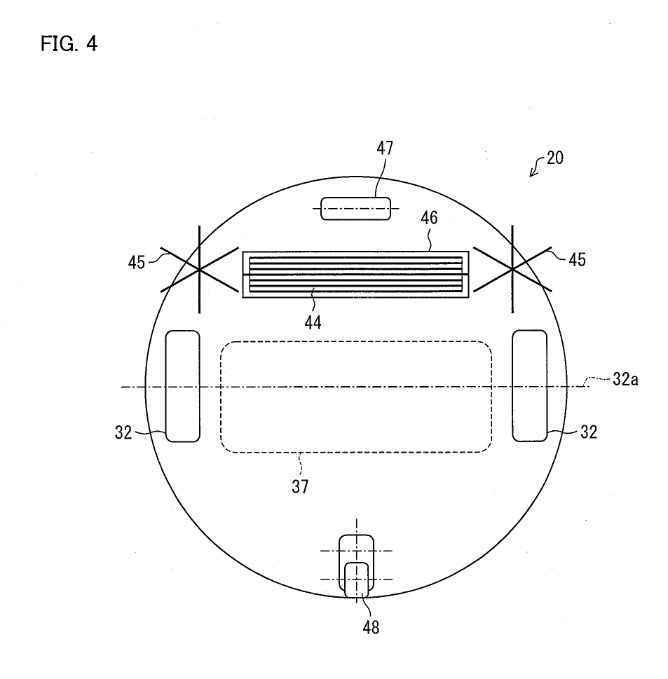

FIG. 2 is a perspective view of the self-propelled electronic device 20 of the present embodiment (self-propelled cleaner). FIG. 3 is a cross-sectional view of the self-propelled electronic device 20. FIG. 4 is a plan view of the self-propelled electronic device 20 taken toward a bottom surface thereof (surface facing a floor).

The self-propelled electronic device 20 includes (i) a body of the self-propelled electronic device 20 (self-propelled cleaner) which body has an outer frame formed of a housing 30 substantially in the shape of a disc having an outer diameter of approximately 35 cm and (ii) driving wheels 32 that are driven on electric power from the battery (secondary battery) 31 as an electric power supply source. The self-propelled electronic device 20 has a function of collecting dust (cleaning) while it is self-propelled.

The self-propelled electronic device 20 includes, on an upper surface of the housing 30, a lid section 34, an operation section 35, and an infrared transmitting section 36. The housing 30 of the present embodiment has an upper surface and a bottom surface that are circular in shape. The shape of the housing 30 is, however, not particularly limited.

The lid section 34 is openable and closable on the housing 30. The lid section 34 can be opened so that a dust collecting container 38 placed in a dust collecting section 37 inside the housing 30 can be detached for disposal of dust inside the dust collecting container 38.

The operation section 35 includes (i) an operation switch (operation section) for receiving any of various instructions and entry of data such as characters and numbers by the user and (ii) a display (display section) for displaying various pieces of information given to the user. The operation section 35 may be a touch panel.

The infrared transmitting section (operation signal transmitting section) 36 serves to transmit an infrared signal (remote control signal; operation signal) from the self-propelled electronic device 20 to another household electric appliance. The present embodiment involves an infrared transmitting section 36 including a plurality of infrared light sources so angled as to emit respective light beams having respective principal-axis directions different from one another. This arrangement allows the self-propelled electronic device 20 to output infrared signals in the horizontal direction and up-and-down direction at angles in a relatively wide range. The configuration of the infrared transmitting section 36 is not particularly limited. The infrared transmitting section 36 may include any appropriate number of infrared light sources each with any appropriate range of angles of infrared-signal emission. The infrared transmitting section 36 may, for example, be provided with a lens so positioned as to face respective emission surfaces of the infrared light sources for the self-propelled electronic device 20 to emit infrared signals omnidirectionally or at angles in a wide range. The infrared transmitting section 36 may be included in the self-propelled electronic device 20 or detachably attached to the self-propelled electronic device 20. The operation signal that the self-propelled electronic device 20 transmits to another household electric appliance is not limited to an infrared signal, and may alternatively be a signal in a different wavelength range.

The housing 30 is provided with, on a side surface thereof, a bumper 39 for softening an impact caused on the housing 30 in the case where the housing 30 has bumped on a house wall or the like. The bumper 39 has, (i) at a portion thereof, a hole at which the image capturing section 40 is provided and (ii) at a portion thereof, another hole at which the ultrasonic sensor 41 is provided.

The image capturing section 40 captures an image (a moving image and/or a static image) of the surroundings of the self-propelled electronic device 20 to generate captured-image data. The configuration of the image capturing section 40 is not particularly limited. Conventionally publicly known image capturing means can be employed as the image capturing section 40. For example, image capturing means including an optical lens, a color filter, and a CCD (Charge Coupled Device) as a light receiving element may be employed as the image capturing section 40. The self-propelled electronic device 20 may include, in addition to the image capturing section 40, a sound recording section (not shown) for recording sound around the self-propelled electronic device 20.

The ultrasonic sensor 41 outputs an ultrasonic wave to an area around the self-propelled electronic device 20 and receives an ultrasonic wave reflected by an obstruction. The ultrasonic sensor 41 thus detects the position of such an obstruction present around the self-propelled electronic device 20.

As illustrated in FIG. 4, the housing 30 is provided with, on its bottom surface, driving wheels 32, a front wheel 47, a rear wheel 48, a rotary brush 44, side brushes 45, and a suction port 46.

The driving wheels 32 are disposed on the bottom surface of the housing 30 at respective ends of a center line 32a of a circle formed by the bottom surface. The driving wheels 32 are each so attached to a rotary shaft (not shown) extending parallel to the center line 32a that a portion of each of the driving wheels 32 protrudes from the bottom surface of the housing 30. The rotary shafts are driven to rotate in the case where the move driving section 61 (see FIG. 1) such as a motor and gears (not shown) is driven on electric power supplied from the battery 31. This causes the driving wheels 32 to rotate, so that the self-propelled electronic device 20 is self-propelled on a floor surface.

The driving wheels 32 are separately driven for rotation. In the case where the driving wheels 32 are driven to rotate in the same direction, the self-propelled electronic device 20 moves forward or backward depending on the direction in which the driving wheels 32 rotate. In the case where the driving wheels 32 are driven to rotate in respective directions opposite to each other, the self-propelled electronic device 20, in correspondence with the directions in which the driving wheels 32 rotate, rotates (turns) in a direction parallel to its bottom surface at the current position. This operation can change the direction in which the self-propelled electronic device 20 moves. The self-propelled electronic device 20 may be (i) provided with a sensor (not shown) for detecting whether the bumper 39 has bumped on a house wall or the like, and be thus (ii) arranged to, in the case where the self-propelled electronic device 20 has bumped on a house wall or the like while it is moving, change its moving direction and continue moving. Alternatively, the self-propelled electronic device 20 may be arranged to (i) detect obstructions such as a house wall and furniture on the basis of, for example, a result of the detection by the ultrasonic sensor 41 and/or result of the image capturing by the image capturing section 40 and to (ii) move while automatically avoiding such obstructions.

The housing 30 has, on its bottom surface, a rectangular suction port 46 formed of a portion depressed toward the inside of the housing 30. Further, the housing 30 is provided with a rotary brush 44 inside the suction port 46 (depression). The rotary brush 44 is rotated about a rotary shaft parallel to the bottom surface of the housing 30. The housing 30 is further provided with side brushes 45 at respective positions near the suction port 46 at respective ends of the suction port 46 along its longitudinal direction. The side brushes 45 are each rotated about a rotary shaft perpendicular to the bottom surface of the housing 30. The rotary brush 44 and side brushes 45 are rotated in the case where the brush driving section 62 (see FIG. 1) drives, in response to an instruction from the control section 21 and on electric power supplied from the battery 31, the respective rotary shafts for the rotary brush 44 and side brushes 45 for rotation.

The housing 30 is further provided with, on its bottom surface, (i) a roller-shaped front wheel 47 at a position further forward of the suction port 46 and (ii) a rear wheel 48 formed of a sprung axle and disposed near the back end (rear end) of the bottom surface. The self-propelled electronic device 20 has a weight distribution in the front-to-rear direction which weight distribution is set so that in the case where the self-propelled electronic device 20 is placed on a flat floor surface, the rotary brush 44, the driving wheels 32, and the rear wheel 48 are in contact with the floor surface F, whereas the front wheel 47 is off the floor surface F. The self-propelled electronic device 20 thus performs cleaning with the front wheel 47 off the floor surface F. This arrangement (i) prevents dust present ahead of the self-propelled electronic device 20 along its moving path from being blocked by the front wheel 47 and (ii) allows such duct to be sucked into the suction port 46. The front wheel 47, in the case where there is a step ahead of the self-propelled electronic device 20 along its moving path, comes into contact with such a step, allowing the self-propelled electronic device 20 to climb over such that step easily.

The housing 30 is provided with, at a rear end of a circumferential surface (side surface) thereof, charging terminals 49 so disposed for use to charge the battery 31 as to be exposed to the outside from the housing 30. In the present embodiment, the housing 30 is provided with, at a rear end of its circumferential surface, two charging terminals 49 that are so disposed as to be separated from each other by a predetermined gap along the vertical direction and that extend in a direction substantially parallel to the floor surface. The housing 30 may, however, be provided with any other number of charging terminals 49 at any other positions.

In order to charge the battery 31, the self-propelled electronic device 20, as illustrated in FIG. 3, returns to a charging station 70 (home position), and the charging terminals 49 come into contact with power supply terminals 71 with which the charging station 70 is provided, so that the battery 31 is charged. The charging station 70 is normally placed so that a back surface (opposite to a side where the power supply terminals 71 are provided) of the charging station 70 faces an internal side wall S of a room. The charging station 70 supplies electric power to the self-propelled electronic device 20 via the power supply terminals 71, the electric power being supplied from a commercial power supply. The charging station 70 is placed at a predetermined constant position on a floor.

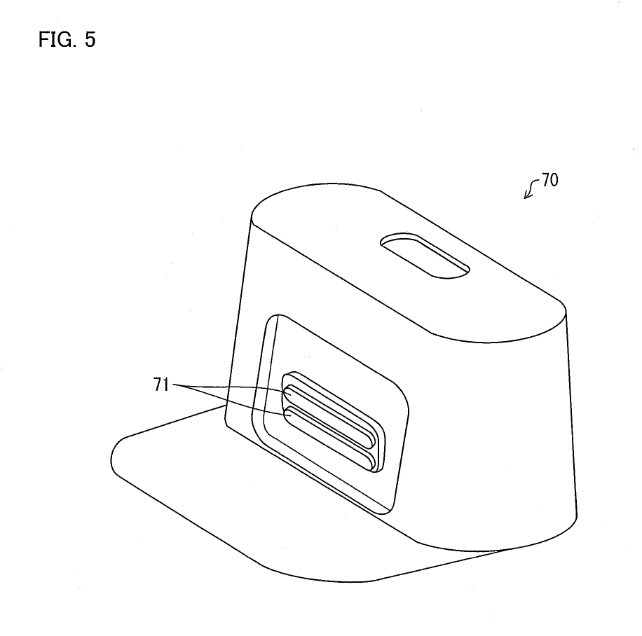

FIG. 5 is a perspective view of the charging station 70, the view illustrating a configuration thereof. As illustrated in FIG. 5, the charging station 70 includes, on a front surface thereof (that is, a surface facing the circumferential surface of the housing 30), the same number of power supply terminals 71 as that of the charging terminals 49 of the self-propelled electronic device 20. The power supply terminals 71 extend in a direction substantially parallel to the floor surface, and are so positioned as to be capable of coming into contact with the charging terminals 49 of the self-propelled electronic device 20. The power supply terminals 71 are so urged by urging means (not shown) such as a spring as to protrude from the front surface of the charging station 70 toward the outside of the charging station 70. In the case where the self-propelled electronic device 20 is caused to return to (or dock at) the charging station 70, the power supply terminals 71 are pushed by the charging terminals 49 in a direction against the urging force of the urging means. This arrangement allows the urging means to push the power supply terminals 71 back until the power supply terminals 71 have respective front end surfaces substantially flush with the front surface of the charging station 70. In the case where the power supply terminals 71 have been pushed until their respective front end surfaces are substantially flush with the front surface of the charging station 70 while the charging terminals 49 of the self-propelled electronic device 20 are in contact (electric connection) with the power supply terminals 71 of the charging station 70, the power supply terminals 71 each become electrically connected to a contact point (not shown) inside the charging station 70. This allows electric power supplied from a commercial power supply to the charging station 70 to be supplied through the power supply terminals 71 and the charging terminals 49 to the self-propelled electronic device 20, thereby charging the battery 31.

The battery 31 is an electric power supply source which supplies electric power to the whole self-propelled electronic device 20. The configuration of the battery 31 is not particularly limited. Examples of the battery 31 include a lead battery, a nickel hydrogen battery, a lithium ion battery, and a capacitor. Note that the battery 31 is preferably a high-capacity rechargeable battery which can be repetitively charged and discharged.

The voltage detecting section 64 detects a voltage of the battery 31, and finds, from the detected voltage, how much the battery 31 is to be charged.

The electric conduction detecting section 65 detects the amount of electric conduction from the power supply terminals to the charging terminals 49. The amount of electric conduction is indicated by (i) the value of a current supplied from the power supply terminals 71 through the charging terminals 49 to the battery 31 and/or (ii) the value of a voltage applied by the power supply terminals 71 to the charging terminals 49.

The housing 30 contains a dust collecting section 37 for collecting dust. The dust collecting section 37 is contained in a dust collection chamber 50 inside the housing 30. The dust collection chamber 50 is an isolated chamber having side surfaces at the four sides and a bottom surface, and extends along the axis direction of the rotary brush 44 in such a manner as to partition the housing 30. The wall surfaces of the dust collection chamber 50 are each continuous except for a front wall extending along the axis direction of the rotary brush 44. The front wall of the dust collection chamber 50 has a first air-intake path 51 in communication with the suction port 46.

The dust collecting section 37 is opened to the outside of the housing 30 in the case where the lid section 34 on the housing 30 is opened. The dust collecting section 37 is formed of (i) a dust collecting container 38 having a bottom and (ii) an upper cover 53 attached to an upper portion of the dust collecting container 38 and provided with a filter 52. The upper cover 53 is locked on the dust collecting container 38 by means of a movable locking section (not shown). Operating that locking section causes an upper surface of the dust collecting container 38 to open and close. This allows dust accumulated in the dust collecting container 38 to be disposed of.

The dust collecting container 38 has, on a circumferential surface thereof, an inflow path 54 in communication with the first air-intake path 51. Further, the dust collecting container 38 is provided with, inside itself, an inflow section 54b that is continuous with the inflow path 54 and that is bent to guide air flow in a downward direction. The upper cover 53 has, on a circumferential surface thereof, an outflow path 55 for communication between the inside of the dust collecting container 38 and the second air-intake path 56. The second air-intake path 56 is located for communication between a motor unit 57 described below and the outflow path 55.

The dust collecting container 38 is provided with a gasket (not shown) so disposed around respective openings of the inflow path 54 and outflow path 55 as to be in close contact with the front wall of the dust collection chamber 50. This structure hermetically seals the dust collection chamber 50, which contains the dust collecting section 37.

The housing 30 contains a control substrate 42 at an upper portion backward of the dust collection chamber 50. The control substrate 42 is provided with (i) the control section 21, which controls the individual sections of the self-propelled electronic device 20, and (ii) the storage section 24, which stores various pieces of data. The housing 30 further contains a battery 31 at a lower portion backward of the dust collection chamber 50. The battery 31 is charged with electric power supplied from the charging station 70 through the charging terminals 49. The battery 31 supplies electric power to such sections as the control substrate 42, the driving wheels 32, the rotary brush 44, the side brushes 45, and the suction fan 58.

The self-propelled electronic device 20, upon receipt of an instruction to perform a cleaning operation, drives the suction fan 58, the driving wheels 32, the rotary brush 44, and the side brushes 45 on electric power supplied from the battery 31. The suction fan 58 is driven in the case where the fan driving section 63 (see FIG. 1) drives the motor unit 57. With this driving, (i) the self-propelled electronic device 20 is self-propelled in a predetermined cleaning region with the rotary brush 44, the driving wheels 32, and the rear wheel 48 in contact with the floor surface F, and (ii) an air flow including dust on the floor surface F is sucked into the suction port 46. This operation causes (i) the rotary brush 44 to rotate and thus catch dust on the floor surface F to lift it into the suction port 46 and (ii) the side brushes 45 to rotate and thus guide dust present to the left and right of the suction port 46 into the suction port 46.

The air sucked into the suction port 46 flows through the first air-intake path 51 into the dust collecting section 37 as indicated by the arrow A1 in FIG. 3. The air having flown in the dust collecting section 37 flows through the filter 52, which catches the dust included in the air. The air then flows through the outflow path 55 out of the dust collecting section 37. This allows dust to be collected and accumulated inside the dust collecting container 38. The air having flown out of the dust collecting section 37 flows through the second air-intake path 56 into the suction fan 58 of the motor unit 57 as indicated by the arrow A2.

The air having flown through the suction fan 58 is discharged from an exhaust port 59 on the upper surface of the housing 30 in a direction upward and backward of the self-propelled electronic device 20 as indicated by the arrow A3.

(1-1-3. Configuration of Server Device 80)

The server device 80, as illustrated in FIG. 1, includes a control section 81, a communication section 82, and a storage section 83.

The control section 81 is control means included in the server device 80 which control means controls operations of the sections of the server device 80. The control section 81 is constituted by a computer device that includes (i) a computation section such as a CPU or a dedicated-purpose processor and (ii) a memory such as a RAM, a ROM or an HDD (none of which is illustrated in FIG. 1). The control section 81 controls the operations of the sections of the server device 80 by (i) reading, from the storage section, various pieces of information and programs for executing various controls and (ii) executing those programs. The control section 81 further has a function of (i) reading an electronic device control application stored in an electronic device control application storage section 84 and (ii) executing that electronic device control application.

The communication section 82 is communication means for communicating with another device via the communication network 90. The communication network 90 can be any of the examples listed above.

The storage section 83 is storage means for storing various pieces of information used by the electronic device controlling system 100, and includes an electronic device control application storage section 84 and a setting information storage section 85.

The electronic device control application storage section 84 stores an electronic device control application that is activated in the case where (i) the user controls the operation of the self-propelled electronic device 20 via the communication network 90 with use of the communication terminal device 10 and the case where (ii) the user registers various pieces of setting information on the control of the self-propelled electronic device 20.

Examples of the electronic device control application include (i) a setting application for generating and registering setting information on the self-propelled electronic device 20, (ii) an authentication application for performing a login authentication, and (iii) a device function performing application for causing the self-propelled electronic device 20 to perform such functions as an image capturing function (“Observe” function), a cleaning function (“Clean up” function), a moving function (“Move” function), and a household electric appliance operating function (“Household electric appliance” function).

The present embodiment is arranged such that in the case where (i) the user controls the operation of the self-propelled electronic device 20 via the communication network 90 with use of the communication terminal device 10 or the case where (ii) the user registers various pieces of setting information on the control of the self-propelled electronic device 20, the user (i) uses the communication terminal device 10 to access the server device 80 to activate an electronic device control application and (ii) enters various instructions on an interface screen provided by that electronic device control application. This causes the electronic device control application to (i) generate a control command responding to the instruction entered by the user and (ii) transmit that control command to the self-propelled electronic device 20, thereby causing the self-propelled electronic device 20 to perform an operation corresponding to the instruction entered. The above operation may alternatively cause the electronic device control application to (i) generate setting information corresponding to the instruction entered by the user and (ii) store that setting information in the setting information storage section 85.

Examples of the setting information stored in the setting information storage section 85 include (i) user authentication information associating the self-propelled electronic device 20 with user information on a user who is permitted to control the operation of the self-propelled electronic device 20, (ii) terminal authentication information associating the self-propelled electronic device 20 with a communication terminal device 10 that is permitted to control the operation of the self-propelled electronic device 20, and (iii) layout information (room arrangement information) on the space (region) in which the self-propelled electronic device 20 is placed. The layout information refers to information on (i) the space (region) in which the self-propelled electronic device 20 is placed or (ii) any object present in that space. The layout information is, in particular, information including information on at least one of the space, or the outline, placement, and properties of the object.

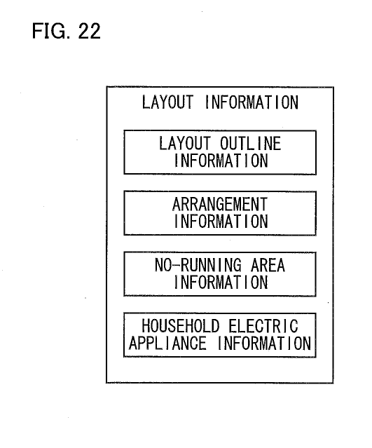

FIG. 22 is an explanatory diagram illustrating an example structure of the layout information. As illustrated in FIG. 22, the layout information includes, for example, (i) layout outline information indicative of the size, shape and the like of the space (for example, a room, a house, or a facility) in which the self-propelled electronic device 20 is placed, (ii) arrangement information indicative of how objects such as furniture and household electric appliances are arranged, (iii) no-running area information indicative of a region in which the self-propelled electronic device 20 is unable to run (or a region in which the user does not want the self-propelled electronic device 20 to run), and (iv) household electric appliance information indicative of, for example, the name of the manufacturer of each household electric appliance placed in the space in which the self-propelled electronic device 20 is placed, the model of the household electric appliance, the name that the user has given to the household electric appliance, operation contents that the user is allowed to instruct the household electric appliance to perform through a remote control operation, and operation signal information (for example, the frequency and signal waveform) about a remote control signal (operation signal) for causing the household electric appliance to perform an operation for an operation content. The operation signal information may be operation signal information that the user has optionally learned. The operation signal information can be obtained by, for example, recording an operation signal that a remote control transmits (as with a commercially available learning remote control). The layout information is set in advance by the user, and is stored in the setting information storage section 85 by the user. In the case where the user enters an instruction into the electronic device control application, the electronic device control application refers to the layout information to, for example, (i) generate an interface screen (layout screen) to be displayed by the communication terminal device 10 or (ii) select (search for) a moving route along which the self-propelled electronic device 20 is to be moved.

The present embodiment is arranged such that the user controls the operation of the self-propelled electronic device 20 via the server device 80 with use of the communication terminal device 10. The present invention is, however, not limit to such an arrangement. The present invention may alternatively be arranged, for instance, such that the functions of the server device 80 are performed by the communication terminal device 10 or self-propelled electronic device 20 and that the communication terminal device 10 accesses the self-propelled electronic device 20 via the communication network 90 or device-to-device communication (short-distance communication) to control the operation of the self-propelled electronic device 20. In this case, the communication terminal device 10 or self-propelled electronic device 20 is an example of the layout information creating device of the present invention. The present invention may further alternatively be arranged such that at least one of the functions of the server device 80 of the present embodiment is performed by the communication terminal device 10 or self-propelled electronic device 20. In this case, a combination of the server device 80, the communication terminal device 10, and/or the self-propelled electronic device 20 is an example of the layout information creating device of the present invention.

(1-2. Activation of Electronic Device Control Application)

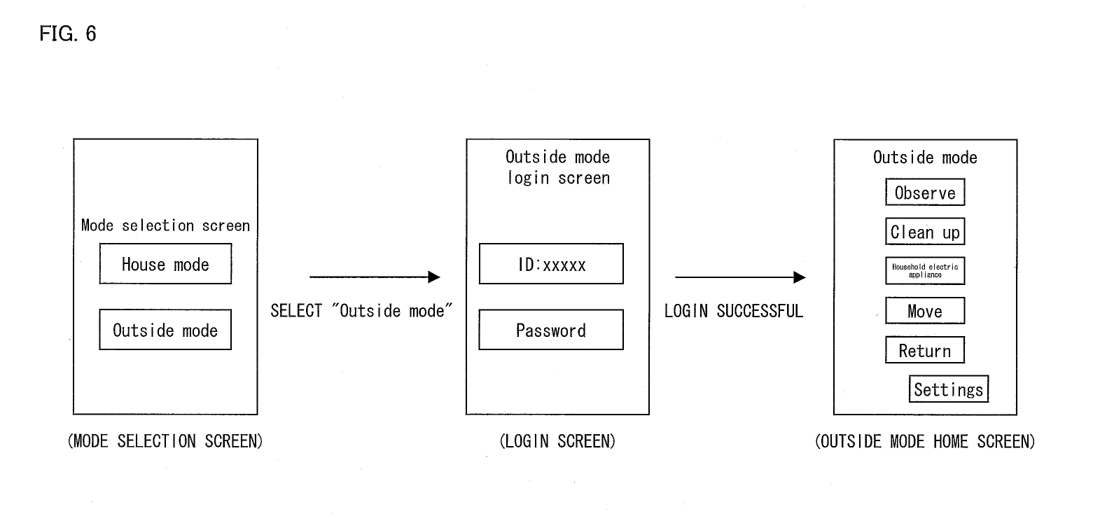

FIG. 6 is an explanatory diagram illustrating how in the electronic device controlling system 100, a display screen displayed by the communication terminal device 10 transitions in the case where the user accesses the server device 80 with use of the communication terminal device 10 to activate an electronic device control application.

In the case where the user has selected the self-propelled electronic device 20 (that is, an electronic device control application corresponding to the self-propelled electronic device 20) on a home screen of the communication terminal device 10, the communication terminal device 10 causes the display section 13 to display an initial screen for that electronic device control application. The example illustrated in FIG. 6 shows the display section 13 displaying as the initial screen a “mode selection screen”, which allows the user to select either a “House mode” or an “Outside mode”. The initial screen may be obtained from the server device 80 by the communication terminal device 10 by transmitting an initial screen transmission request to the server device 80 (electronic device control application), or may be stored in advance in the storage section 15 of the communication terminal device 10.

The “Outside mode” is a mode in which the user of the communication terminal device 10 controls the operation of the self-propelled electronic device 20 by transmitting, from the communication section 12 via the communication network 90 to the self-propelled electronic device 20, a control command responding to an instruction entered by the user into the communication terminal device 10 via the operation section 14.

The “House mode” is a mode in which the user of the communication terminal device 10 controls the operation of the self-propelled electronic device 20 by transmitting, from the communication section 12 via a device-to-device communication (short-distance communication) to the self-propelled electronic device 20, a control command responding to an instruction entered by the user into the communication terminal device 10 via the operation section 14. In the “House mode”, the user can, for instance, see the self-propelled electronic device 20 while controlling the operation of the self-propelled electronic device 20 to cause the self-propelled electronic device 20 to perform any of various functions (for example, the cleaning function or moving function). The description of the present embodiment deals mainly with the case of controlling the operation of the self-propelled electronic device 20 in the “Outside mode”.

In the case where the user has selected the “Outside mode” on the initial screen illustrated in FIG. 6, the communication terminal device 10 transmits a signal indicative of the selection operation to the server device 80. In response, the electronic device control application transmits to the communication terminal device 10 data on a “login screen” for a user authentication. The present embodiment may be arranged such that in the case where the user uses the “Outside mode” for the first time, the communication terminal device 10 displays (i) a screen showing terms of service for the “Outside mode” before displaying the “login screen” and displays (ii) the login screen (or a user registration screen) if the user has agreed to the terms of service.

In the case where the user has entered user authentication information (for example, an ID and password) on the “login screen”, the communication terminal device 10 transmits that user authentication information to the server device 80. The electronic device control application then performs a user authentication process on the basis of the user authentication information. In the case where the electronic device control application has determined as a result of the user authentication process that the electronic device control application permits the user to control the operation of the self-propelled electronic device 20 through the electronic device controlling system 100, the electronic device control application transmits to the communication terminal device 10 data on a home screen for the “Outside mode” (“outside mode home screen”). The communication terminal device 10 then causes the display section 13 to display that home screen. The present embodiment may be arranged such that in the case where the communication terminal device 10 (or the user operating the communication terminal device 10) is not associated (not paired) with the self-propelled electronic device 20 as a control target, the communication terminal device 10 (i) causes the display section 13 to display a registration screen for a registration process (pairing process) of registering, in the server device 80, the communication terminal device 10 and the self-propelled electronic device 20 in association with each other and (ii) changes the display screen to the home screen for the “Outside mode” after completion of the registration process.

The home screen for the “Outside mode” displays (i) items for the user to choose how to control the self-propelled electronic device 20 (in the example of FIG. 6, “Observe”, “Clean up”, “Household electric appliance”, “Move”, and “Return”) and (ii) an item for the user to change the settings of the electronic device controlling system 100 (in the example of FIG. 6, “Settings”). The home screen allows the user to select a desired item.

In the case where the user has pressed the “Observe” button, the electronic device control application operating on the server device 80 transmits to the self-propelled electronic device 20 a control command for causing the self-propelled electronic device 20 to perform the “Observe” function. The control section 21 of the self-propelled electronic device 20, in response to that control command, (i) controls operations of individual sections of the device function section 25 (for example, the image capturing section 34) to cause those sections to capture an image of the surroundings of the self-propelled electronic device 20 and (ii) transmits data on the captured image to the server device 80. The electronic device control application transfers to the communication terminal device 10 the captured-image data that has been transmitted from the self-propelled electronic device 20 to the server device 80. This allows the user of the communication terminal device 10 to remotely view an image captured of the surroundings of the self-propelled electronic device 20.

In the case where the user has pressed the “Clean up” button, the electronic device control application operating on the server device 80 transmits to the self-propelled electronic device 20 a control command for causing the self-propelled electronic device 20 to perform the “Clean up” function. The control section 21 of the self-propelled electronic device 20, in response to that control command, controls operations of individual sections of the device function section 25 (for example, the move driving section 61, the brush driving section 62, and the fan driving section 63) to cause those sections to perform the cleaning function.

In the case where the user has pressed the “Household electric appliance” button, the electronic device control application operating on the server device 80 (i) generates, on the basis of layout information stored in the setting information storage section 85, an interface screen that allows the user to choose a household electric appliance as a control target and how to control that household electric appliance and (ii) transmits data on the interface screen to the communication terminal device 10. The electronic device control application then obtains information indicative of instructions entered by the user on the interface screen (specifically, an instruction of selecting from among icons included in the layout image an icon for a household electric appliance as an operation target and an instruction of specifying how to operate the household electric appliance selected). The electronic device control application (i) generates a control command for causing the user's selected household electric appliance to perform an operation responding to the user's instructions and (ii) transmits that control command to the self-propelled electronic device 20. The control section (operation signal generating section) 21 of the self-propelled electronic device 20 then (i) generates an infrared signal (operation signal) responding to the control command from the electronic device control application and (ii) outputs that infrared signal from the infrared transmitting section 36. This causes the self-propelled electronic device 20 to output an infrared signal responding to the user's instructions and thereby allows the household electric appliance as a control target to, upon receipt of the infrared signal, perform the operation responding to the user's instructions.

In the case where the user has pressed the “Move” button, the electronic device control application operating on the server device 80 (i) generates, on the basis of layout information stored in the setting information storage section 85, an interface screen that allows the user to specify a destination for the self-propelled electronic device 20 and (ii) transmits data on the interface screen to the communication terminal device 10. The electronic device control application then obtains information indicative of an instruction entered by the user on the interface screen to specify a destination. The electronic device control application, on the basis of the layout information stored in the setting information storage section 85 and the user's instruction to specify a destination, searches for a moving route along which to move the self-propelled electronic device 20 to the destination responding to the user's instruction. The electronic device control application then (i) generates a control command for causing the self-propelled electronic device 20 to move along a moving route corresponding to a result of the search and (ii) transmits that control command to the self-propelled electronic device 20. In response to the control command from the electronic device control application, the control section 21 of the self-propelled electronic device 20 controls operations of individual sections of the device function section 25 to move the self-propelled electronic device 20. This allows the user of the communication terminal device 10 to remotely move the self-propelled electronic device 20 to a desired position.

The present embodiment is arranged as follows: In the case where the self-propelled electronic device 20 is, in response to a press of the “Move” button, moved to a destination specified by the user, the electronic device control application determines whether the self-propelled electronic device 20 is at a predetermined home position (in the present embodiment, the position at which the charging terminals 49 of the self-propelled electronic device 20 are in contact with the power supply terminals 71 of the charging station 70 so that the battery 31 of the self-propelled electronic device 20 is charged). In the case where the electronic device control application has determined that the self-propelled electronic device 20 is not at the home position, the electronic device control application causes the self-propelled electronic device 20 to first return to the home position and then start moving to the destination.

In the case where the user has pressed the “Return” button, the electronic device control application operating on the server device 80 transmits to the self-propelled electronic device 20 a control command for causing the self-propelled electronic device 20 to return to the predetermined home position.

The control section 21 of the self-propelled electronic device 20 controls operations of individual sections of the device function section 25 in response to the control command from the electronic device control application to cause the self-propelled electronic device 20 to move (return) to the home position. A later description will deal with a method of causing the self-propelled electronic device 20 to return to a home position.

In the case where the user has pressed the “Settings” button, the electronic device control application operating on the server device 80 transmits to the communication terminal device 10 data on a setting screen for the user to enter layout information. The communication terminal device 10 causes the display section 13 to display the setting screen transmitted from the server device 80 (electronic device control application). The communication terminal device 10 then (i) receives an instruction entered by the user on the setting screen and (ii) transmits that instruction to the server device 80 (electronic device control application). This allows the electronic device control application to generate layout information responding to the user's instruction and allows that layout information to be stored in the setting information storage section 85. A later description will deal in detail with a process of generating layout information.

(1-3. Method of Generating Layout Information)

The following description will discuss a method of generating layout information.

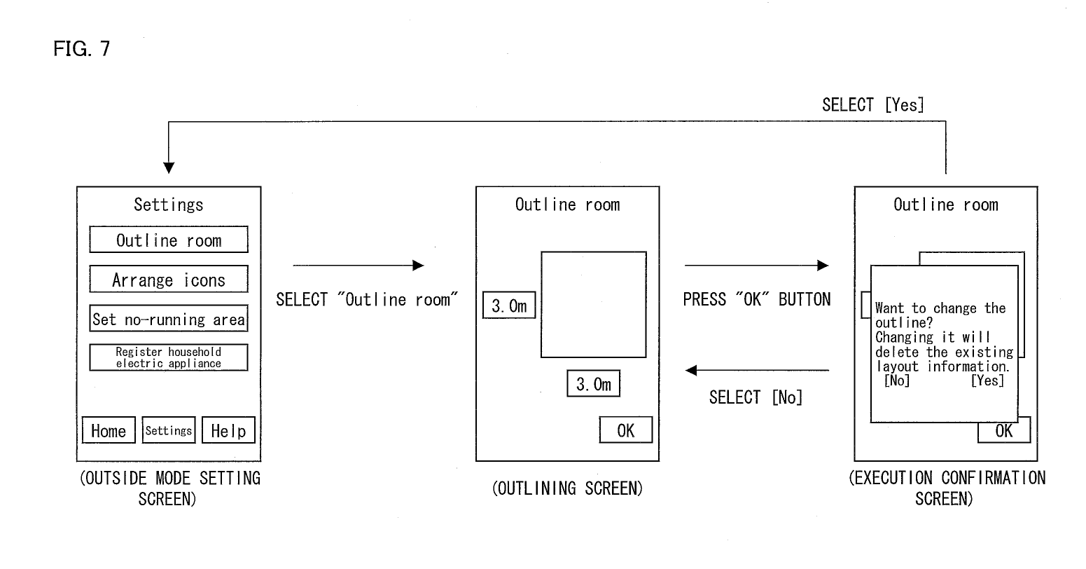

In the case where the user has selected “Settings” on the “outside mode home screen” illustrated in FIG. 6, the display section 13 displays the “outside mode setting screen” illustrated in FIG. 7. Specifically, in the case where the user of the communication terminal device 10 has pressed the “Settings” button on the “outside mode home screen”, the control section 11 of the communication terminal device 10 transmits to the server device 80 information indicative of that operation. The electronic device control application operating on the server device 80, upon receipt of that information, (i) transmits screen data on the “outside mode setting screen” to the communication terminal device 10 and (ii) causes the display section 13 to display the “outside mode setting screen”.

The “outside mode setting screen” shows respective buttons for “Outline room”, “Arrange icons”, “Set no-running area”, “Register household electric appliance”, “Home”, “Settings”, and “Help”.

The “Outline room” button is a button for setting layout outline information. The “Arrange icons” button is a button for setting arrangement information. The “Set no-running area” button is a button for setting no-running area information. The “Register household electric appliance” button is a button for setting household electric appliance information. Further, the “outside mode setting screen” is so set that (i) pressing the “Home” button causes a transition to the “outside mode home screen”, (ii) pressing the “Settings” button causes a transition to the “outside mode setting screen”, and (iii) pressing the “Help” button causes a help screen to be displayed which shows information that supports the user in operating the communication terminal device 10.

(1-3-1. Setting of Layout Outline Information)

The description below first deals with a method of setting layout outline information. FIG. 7 is an explanatory diagram illustrating images displayed by the display section 13 of the communication terminal device 10 during a process of setting layout outline information.

In the case where the user has selected “Outline room” on the “outside mode setting screen”, the electronic device control application causes the display section 13 of the communication terminal device 10 to display, as illustrated in FIG. 7, an “outlining screen”, which allows the user to set an outline for the space in which the self-propelled electronic device 20 is placed (for example, a layout for a place such as a room, a house, and a facility).

FIG. 7 illustrates an example case of setting information on a rectangular room as the layout outline information, the example allowing the user to set any length and width for a room. Settings of the layout outline information are, however, not limited to this example. The user may set, for example, (i) a layout shape other than a rectangle, (ii) an outline of a layout for a plurality of rooms, or (iii) an outline of a layout including a corridor, a stairway, a lavatory, a bathroom, a kitchen, and an entrance, for example.

The layout outline may alternatively be set in such a manner that the user (i) selects, from among a plurality of layout outline basic patterns stored in advance, a pattern similar to the layout outline of the space in which the self-propelled electronic device 20 is placed and (ii) adjusts, for example, the size and shape of each part of the pattern selected.

In the case where the user has entered a layout outline on the “outlining screen” and pressed the “OK” button, the electronic device control application causes the display section 13 of the communication terminal device 10 to display an “execution confirmation screen”, which asks the user to confirm whether to update the layout outline information.

The “execution confirmation screen” shows information for asking the user to confirm whether to change the layout outline information. In the case where the user has entered an instruction on the “execution confirmation screen” to change the layout outline information (the user has pressed “Yes”), the electronic device control application (i) sets, as set by the user on the “outlining screen”, layout outline information to be stored in the setting information storage section 85 and (ii) causes the display section 13 of the communication terminal device 10 to switch the display screen back to the “outside mode setting screen”.

(1-3-2. Setting of Arrangement Information)

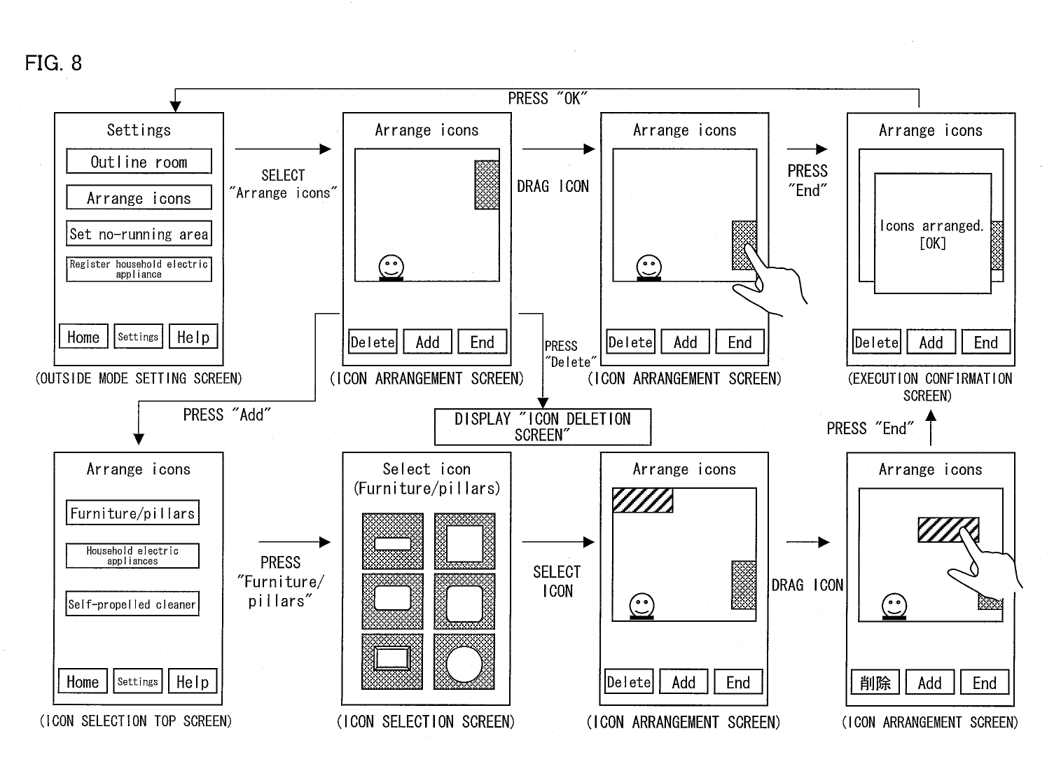

The following description will discuss a method of setting arrangement information, which indicates how objects (such as furniture and household electric appliances) are arranged. FIG. 8 is an explanatory diagram illustrating images displayed by the display section 13 of the communication terminal device 10 during a process of setting arrangement information.

In the case where the user has selected “Arrange icons” on the “outside mode setting screen”, the electronic device control application causes the display section 13 of the communication terminal device 10 to display an “icon arrangement screen” as illustrated in FIG. 8. The “icon arrangement screen” shows, on the basis of layout information stored in the setting information storage section 85, a layout outline and any icon that have been registered. Specifically, the “icon arrangement screen” shows a layout image including (i) a layout outline image indicative of the layout outline and (ii) as superimposed over the layout outline image, any image of an icon indicative of an object (such as furniture and household electric appliances) placed in the space in which the self-propelled electronic device 20 is placed. The “icon arrangement screen” shows respective buttons for “Delete”, “Add”, and “End”.

In the case where the user has dragged an icon superimposed over the layout outline image on the “icon arrangement screen”, the electronic device control application moves that icon on the layout outline image in response to the user's dragging operation. In the case where the user has then moved the icon to a desired position, dropped the icon, and pressed the “End” button, the electronic device control application sets the position of the icon in the arrangement information, stored in the setting information storage section 85, to the position at which the icon has been dropped. The electronic device control application further causes the display section 13 of the communication terminal device 10 to display an “execution confirmation screen”, which indicates that the icon has been relocated. In the case where the user has pressed the “OK” button on the “execution confirmation screen”, the electronic device control application causes the display section 13 to switch the display screen back to the “outside mode setting screen”.

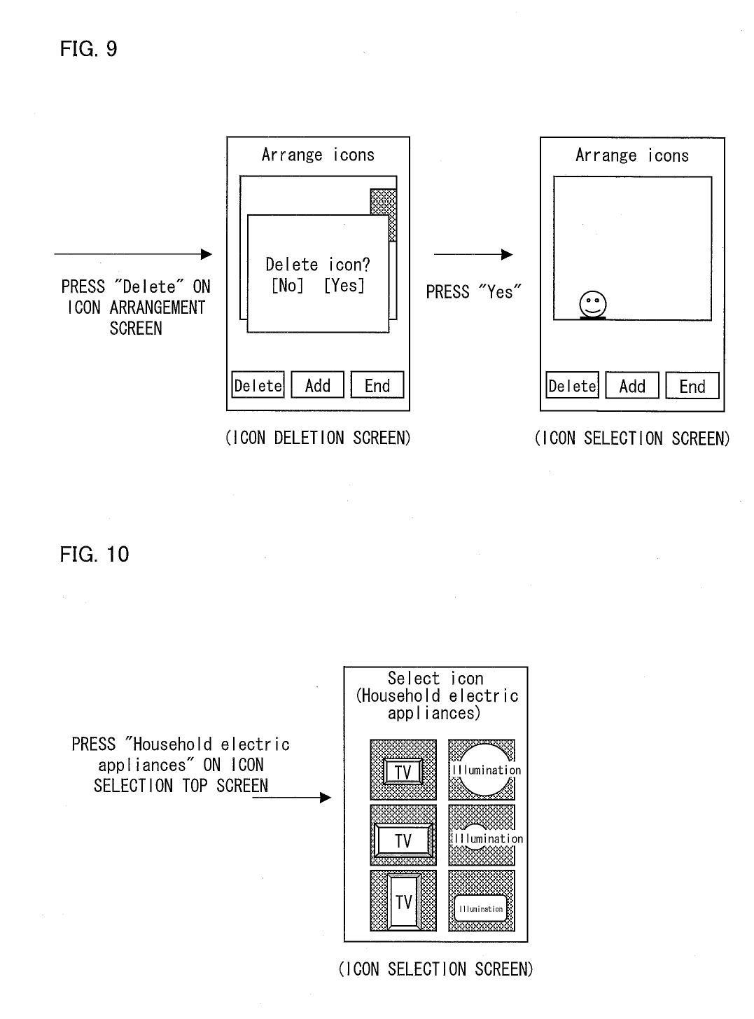

In the case where the user has pressed the “Delete” button on the “icon arrangement screen”, the electronic device control application causes the display section 13 of the communication terminal device 10 to display, as illustrated in FIG. 9, an “icon deletion screen”, which asks the user to confirm whether to delete the icon. In the case where the user has selected “Yes” on the “icon deletion screen”, the electronic device control application deletes, from the arrangement information stored in the setting information storage section 85, the icon selected by the user. The electronic device control application, after deleting the icon, causes the display section 13 of the communication terminal device 10 to switch the display screen back to the “outside mode setting screen”.

In the case where the user has pressed the “Add” button on the “icon arrangement screen”, the electronic device control application causes the display section 13 of the communication terminal device 10 to display an “icon selection top screen” as illustrated in FIG. 8. The “icon selection top screen” is a screen for the user to select a type of an icon to be placed. The example of FIG. 8 allows the user to select, from “Furniture/pillars”, “Household electric appliance”, and “Self-propelled cleaner”, an item corresponding to an object to be placed.

In the case where the user has selected on the “icon selection top screen” an item corresponding to the object to be placed, the electronic device control application causes the display section 13 of the communication terminal device 10 to display an “icon selection screen”, which selectably shows a plurality of icons of objects belonging to the item selected. In the case where, for instance, the user has selected “Furniture/pillars”, the electronic device control application causes the display section 13 to display a plurality of icons of furniture, a pillar and the like as illustrated in FIG. 8. The user then selects, from among the plurality of icons, an icon corresponding to the object to be placed.

In the case where the user has selected “Household electric appliance”, the electronic device control application causes the display section 13 to display a plurality of icons of various household electric appliances as illustrated in FIG. 10. The user then selects, from among the plurality of icons, an icon corresponding to a household electric appliance to be placed.

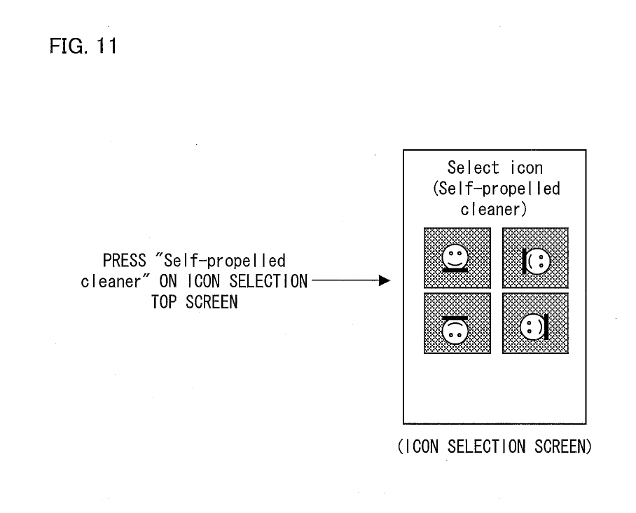

In the case where the user has selected “Self-propelled cleaner”, the electronic device control application causes the display section 13 to display, as illustrated in FIG. 11, a plurality of icons each indicative of a direction in which the self-propelled cleaner (self-propelled electronic device 20) and the charging station 70 are placed relative to each other. The user then selects, from among the plurality of icons, an icon corresponding to a direction in which the charging station 70 is placed.

In the case where the user has selected on the “icon selection screen” an icon corresponding to the object to be registered, the electronic device control application causes the display section 13 of the communication terminal device 10 to display an “icon arrangement screen” as illustrated in FIG. 8. In its initial state, the “icon arrangement screen” shows the user's selected icon at a predetermined position (in the example of FIG. 8, at the upper left corner). As in the above case, the user can then, by dragging an icon superimposed over the layout outline image included in the layout image shown on the “icon arrangement screen”, move the icon to a desired position. In the case where the user has moved the icon to a desired position and pressed the “End” button, the electronic device control application sets the icon and its placement position in the arrangement information stored in the setting information storage section 85. The electronic device control application further causes the display section 13 of the communication terminal device 10 to display an “execution confirmation screen”, which indicates that the icon has been placed. In the case where the user has pressed the “OK” button on the “execution confirmation screen”, the electronic device control application causes the display section 13 to switch the display screen back to the “outside mode setting screen”.

The present embodiment is arranged such that the electronic device control application allows the layout information to include no-running area information in addition to the layout outline information and the arrangement information. The following description will discuss a method of generating no-running area information.

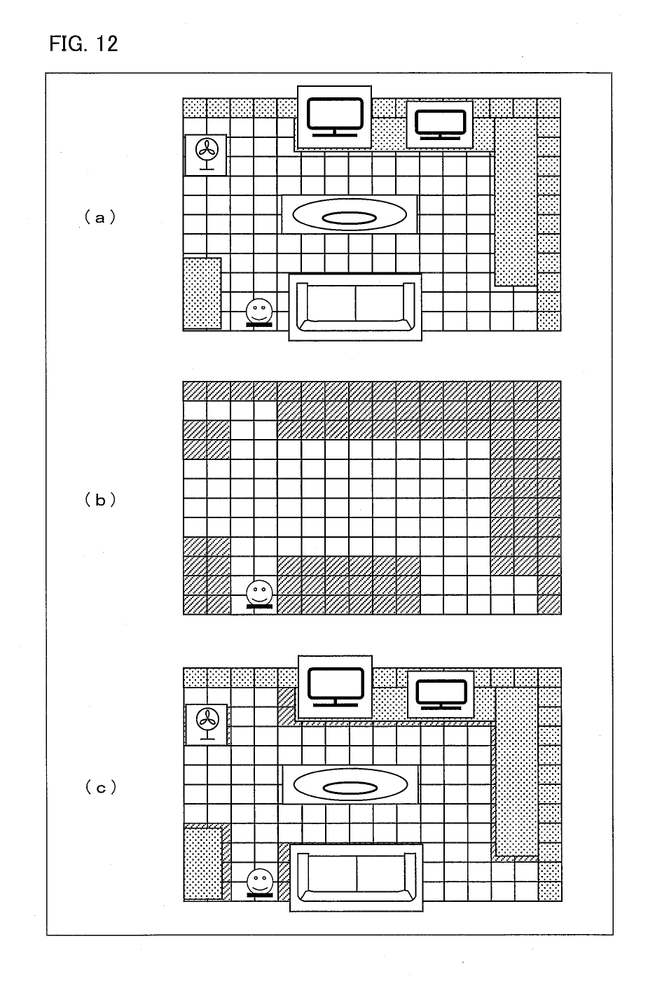

(a) of FIG. 12 is an explanatory diagram illustrating an example of the “icon arrangement screen” displayed by the display section of the communication terminal device 10 on the basis of layout outline information and arrangement information. (b) of FIG. 12 is an explanatory diagram illustrating no-running area information corresponding to (a) of FIG. 12.

As illustrated in (b) of FIG. 12, the electronic device control application generates no-running area information that divides the floor surface of a space specified on the basis of layout outline information into a large number of blocks in a matrix and that indicates whether the individual blocks each belong to (i) a running block (running area), in which the self-propelled electronic device 20 is able to run, or (ii) a no-running block (no-running area), in which the self-propelled electronic device 20 is unable to run.

The present embodiment uses blocks each having a size of 25 cm×25 cm. This allows the electronic device control application to easily determine, on the basis of no-running area information, whether the self-propelled electronic device 20 is able to run on a boundary line between adjacent blocks.

More specifically, the self-propelled electronic device 20 of the present embodiment has an outer dimension of approximately 35 cm. Thus, in the case where the self-propelled electronic device 20 runs on a boundary line between two running blocks, the boundary lines located across those two blocks from the boundary line on which the self-propelled electronic device 20 runs are each separated from the outer edge of the self-propelled electronic device 20 by a margin of 7.5 cm (=25−35/2). This arrangement allows the self-propelled electronic device 20 to run without moving beyond the boundary lines located across the two blocks from the boundary line on which the self-propelled electronic device 20 runs. Thus, in the case where the above boundary lines are adjacent to no-running blocks, the self-propelled electronic device 20 is able to run without moving into those no-running blocks. The electronic device control application thus determines in the case where adjacent blocks are both running blocks that the self-propelled electronic device 20 is able to run on the boundary line between those two blocks. On the other hand, the electronic device control application determines in the case where at least one of such adjacent blocks is a no-running block that the self-propelled electronic device 20 is unable to run on the boundary line between those two blocks.

The no-running area information may specify a size for a block (that is, the length of one side) other than the above size (25 cm×25 cm). However, to prevent the self-propelled electronic device 20 from partially moving into a no-running block when running, the blocks each need to have a size that is at least larger than a half of an outer diameter of the self-propelled electronic device 20 which outer diameter is in a direction that is (i) perpendicular to the direction in which the self-propelled electronic device 20 runs and that is (ii) parallel to the floor surface. If the blocks are excessively large, it may decrease the accuracy in searching for an optimal running route for the self-propelled electronic device 20 on the basis of no-running area information. The no-running area information thus preferably specifies a size for a block (that is, the length of one side) which size is not larger than an outer diameter of the self-propelled electronic device 20 which outer diameter is in a direction that is perpendicular to the direction in which the self-propelled electronic device 20 runs and that is parallel to the floor surface. The no-running area information, in other words, preferably specifies a size for a block (that is, the length of one side) which size is (i) larger than a half of an outer diameter of the self-propelled electronic device 20 which outer diameter is in a direction that is perpendicular to the direction in which the self-propelled electronic device 20 runs and that is parallel to the floor surface and (ii) not larger than that outer diameter.

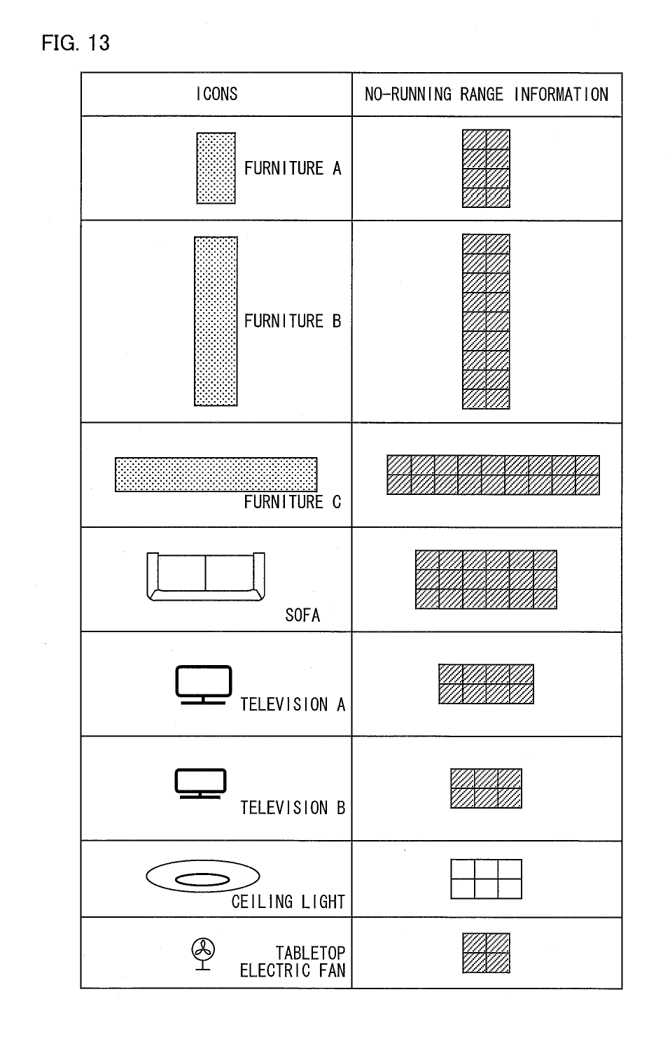

The setting information storage section 85 stores in advance, in association with each other, (i) each icon selectable on the “icon selection screen” described above and (ii) no-running range information, which indicates each block (no-running block, no-running range) corresponding to a range in which in the case where the object corresponding to the icon is placed in the space in which the self-propelled electronic device 20 is placed, the self-propelled electronic device 20 will be prevented from running by that object. FIG. 13 is an explanatory diagram illustrating an example of (i) icons and (ii) no-running range information associated with those icons.

The setting information storage section 85 stores no-running range information indicative of the absence of no-running blocks in association with the icon of an object, such as the ceiling light illustrated in FIG. 13, which is not placed on the floor surface and that is not an obstruction to the running of the self-propelled electronic device 20. As with such a ceiling light, the setting information storage section 85 also stores no-running range information indicative of the absence of no-running blocks in association with the icon of, for example, (i) an air conditioner installed on an upper surface of a wall of the room or on the ceiling of the room or (ii) a wall-mount electric fan.

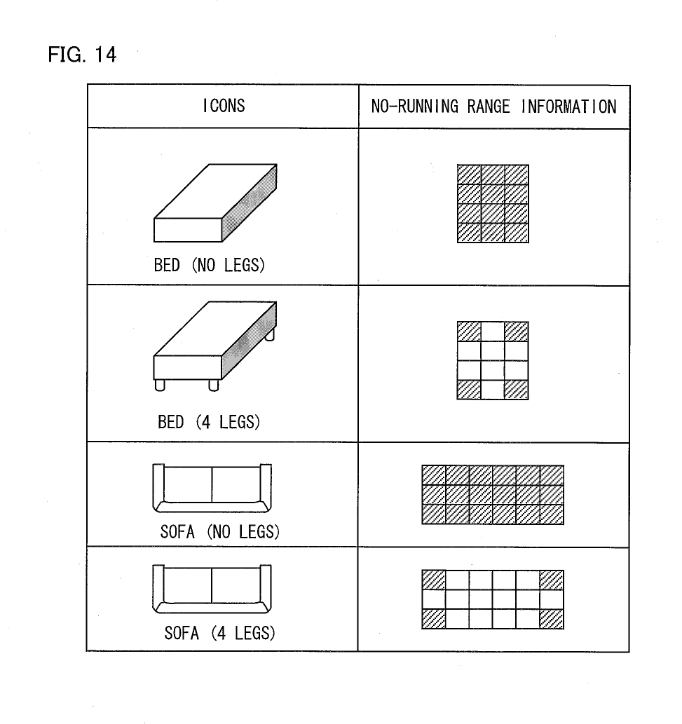

In the case where the self-propelled electronic device 20 is able to run in a portion of the region in which an object corresponding to an icon and installed in the room faces the floor surface, the setting information storage section 85 may store, in association with the icon of that object, no-running range information indicative of running blocks and no-running blocks that are set on the basis of the portion of the region in which portion the self-propelled electronic device 20 is able to run. For instance, as illustrated in FIG. 14, for an object supported by legs and so structured that the self-propelled electronic device 20 is able to run in, of the region in which the object faces the floor surface, a portion in which the legs are absent, the setting information storage section 85 may store no-running range information so set that (i) blocks corresponding to the portion in which the self-propelled electronic device 20 is able to run (that is, the portion in which the legs are absent) are running blocks and (ii) blocks corresponding to a portion in which the self-propelled electronic device 20 is unable to run (that is, the portion in which the legs are present) are no-running blocks.

The present embodiment may also be arranged such that the user can in any manner edit no-running range information stored in the setting information storage section 85 in association with an icon. This arrangement allows the user to, in correspondence with such aspects as the shape and size of the actual object placed and the manner in which that object is placed, appropriately edit no-running blocks associated with the icon of the object to be placed. The above arrangement thus allows more suitable arrangement information to be generated. In addition, in the case where the present embodiment is arranged such that the user can in any manner edit no-running range information associated with an icon, the present embodiment may further be arranged to (i) change the initial settings of the no-running range information for that icon in response to an instruction entered by the user to correct no-running range information and (ii) store in the setting information storage section 85 the no-running range information as changed. This arrangement saves the user from having to repeat the same change the next time the user places the same icon. The above arrangement can thus improve the user's convenience.

In the case where the user has set the respective positions of icons on the “icon arrangement screen”, the electronic device control application generates no-running area information on the basis of (i) the layout outer diameter information, (ii) the respective placement positions of the icons which placement positions have been set by the user, and (iii) the no-running range information stored in association with the icons.

More specifically, the electronic device control application, in the case where the user has set layout outline information, generates (i) an image corresponding to that layout outline information and also generates (ii) no-running area information that shows an outline corresponding to the layout outline information and that divides the inside of the outline into a large number of blocks each shaped to have a size of 25 cm×25 cm. Then, the electronic device control application, in the case where the user has placed icons over the image corresponding to the layout outline information as illustrated in (a) of FIG. 12, shows no-running range information associated with the icons at the respective placement positions of the icons on the no-running area information as illustrated in (b) of FIG. 12. This allows the electronic device control application to generate no-running area information corresponding to (i) layout outline information and (ii) arrangement information for individual icons.

The electronic device control application causes the setting information storage section 85 to store, in association with the layout outline information and the arrangement information, the no-running area information generated. The present embodiment may alternatively be arranged to display, as illustrated in (c) of FIG. 12, (i) a layout image (that is, an image formed of an image corresponding to layout outline information and any icon image over that image which icon image corresponds to arrangement information) and (ii) a no-running area image corresponding to no-running area information (that is, an image in which the inside of the layout outline is divided into a large number of blocks and in which those blocks are identifiably classified into no-running blocks and running blocks) on the “icon arrangement screen”, the layout image and the no-running area image being superimposed over each other.

(1-3-3. Setting of No-running Area Information)

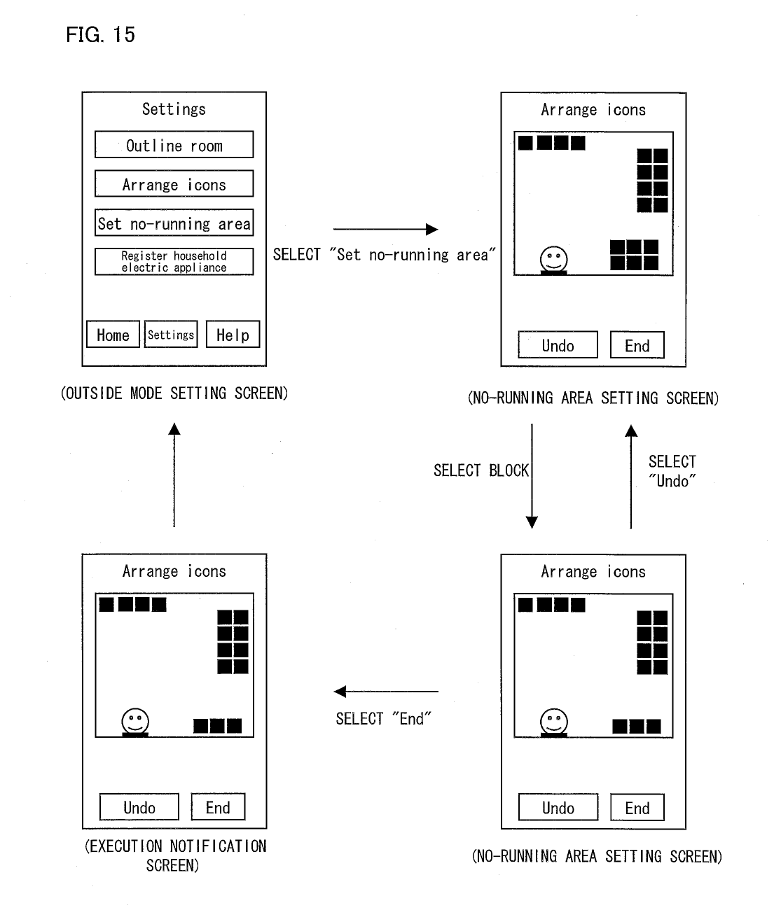

The following description will discuss a method of setting no-running area information. FIG. 15 is an explanatory diagram illustrating example images displayed by the display section 13 of the communication terminal device 10 during a process of setting (editing) no-running area information.

In the case where the user has selected “Set no-running area” on the “outside mode setting screen”, the electronic device control application causes the display section 13 of the communication terminal device 10 to display a “no-running area setting screen” corresponding to no-running area information stored in the setting information storage section 85. The “no-running area setting screen” shows (i) a no-running area image (that is, an image in which the inside of the layout outline is divided into a large number of blocks and in which those blocks are identifiably classified into no-running blocks and running blocks), (ii) an “Undo” button, and (iii) an “End” button.

In the case where the user has selected a block on the “no-running area setting screen”, the electronic device control application toggles that block between no running and running. Specifically, the electronic device control application, in the case where the user has selected a no-running block on the no-running area image, switches that block to a running block, and in the case where the user has selected a running block, switches that block to a no-running block. The electronic device control application temporarily saves the result of the toggle in a working memory.

In the case where the user has pressed the “Undo” button on the “no-running area setting screen”, the electronic device control application (i) abandons the result of the toggle saved in the working memory and (ii) causes the display section 13 to switch the display screen back to the “no-running area setting screen” corresponding to the no-running area information stored in the setting information storage section 85.

In the case where the user has pressed the “End” button on the “no-running area setting screen”, the electronic device control application (i) updates, on the basis of the result of the toggle saved in the working memory, the no-running area information stored in the setting information storage section 85 and (ii) causes the display section 13 of the communication terminal device 10 to switch the display screen back to the “outside mode setting screen”.

The present embodiment is arranged to, even in the case where the user has deleted an icon on the layout outline image, not automatically delete the setting of no running or running for each block corresponding to that icon on the no-running area information, and is arranged such that to delete such a setting, the user selects “Set no-running area” to edit the no-running area information. The present embodiment is, however, not limited to such an arrangement, and may be arranged to, in the case where the user has deleted an icon on the layout outline image, automatically set each block corresponding to that icon in the no-running area to a running block. The present embodiment may alternatively be arranged to, in the case where any block corresponding to the no-running range information for an icon to be deleted in the no-running area corresponds to no-running range information for another icon, sets that block to a no-running block or a running block in correspondence with the no-running range information for the other icon. This arrangement can prevent an inconvenient situation in which, in the case where, for instance, the user has removed a household electric appliance placed on a piece of furniture, blocks corresponding to that household electric appliance are undesirably switched to running blocks although those blocks are no-running blocks due to the furniture.

(1-3-4. Setting of Household Electric Appliance Information)

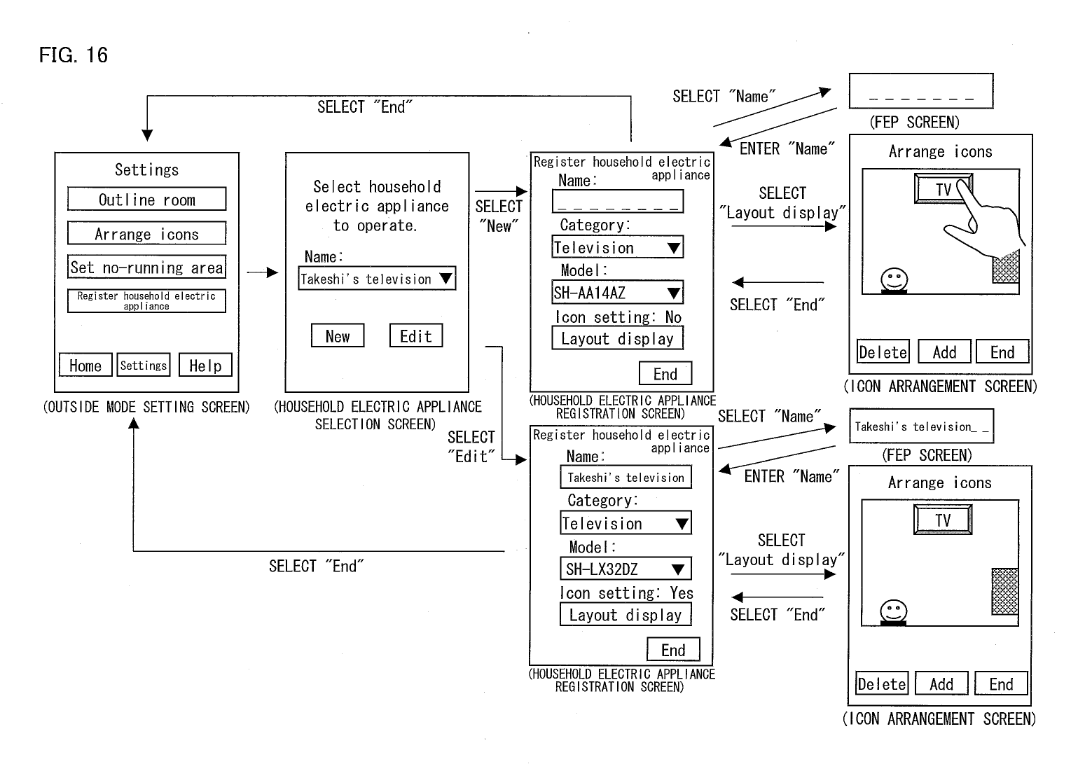

The following description will discuss a method of setting household electric appliance information. FIG. 16 is an explanatory diagram illustrating example images displayed by the display section 13 of the communication terminal device 10 during a process of setting household electric appliance information.

In the case where the user has selected “Register household electric appliance” on the “outside mode setting screen”, the electronic device control application causes the display section 13 of the communication terminal device 10 to display a “household electric appliance selection screen”. The “household electric appliance selection screen” shows a list of registered household electric appliances, a “New” button, and an “Edit” button. The example of FIG. 16 shows (i) the name of one of the registered household electric appliances (“Takeshi's television”) and (ii) a display switch button (black triangle button) next to that name. In the case where the user has pressed the display switch button, the electronic device control application (i) causes the display section 13 to display the list of the registered household electric appliances (not shown) and (ii) allows the user to select a desired household electric appliance from among the registered household electric appliances on the list.

In the case where the user has pressed the “New” button on the “household electric appliance selection screen”, the electronic device control application causes the display section 13 of the communication terminal device 10 to display a “household electric appliance registration screen”. The example of FIG. 16 shows on the “household electric appliance registration screen” (i) an input box for a name for the household electric appliance (that is, a name that the user gives to the household electric appliance), (ii) a selection box for a category of the household electric appliance, (iii) a selection box for the model of the household electric appliance, (iv) information indicative of whether an icon has been set for the household electric appliance, (v) a button for switching to a layout display (display of the “icon arrangement screen”), and (vi) an “End” button. The “household electric appliance registration screen” may show, in addition to the above items, such items as a selection box for the name of the manufacturer of the household electric appliance.

In the case where the user has selected the input box for a name for the household electric appliance, the electronic device control application (i) activates software (front end processor; FEP) for text input and (ii) causes the display section 13 to display a text box for the user to enter a name for the household electric appliance. The user can then enter a desired name into the text box to give that name to the household electric appliance to be registered.

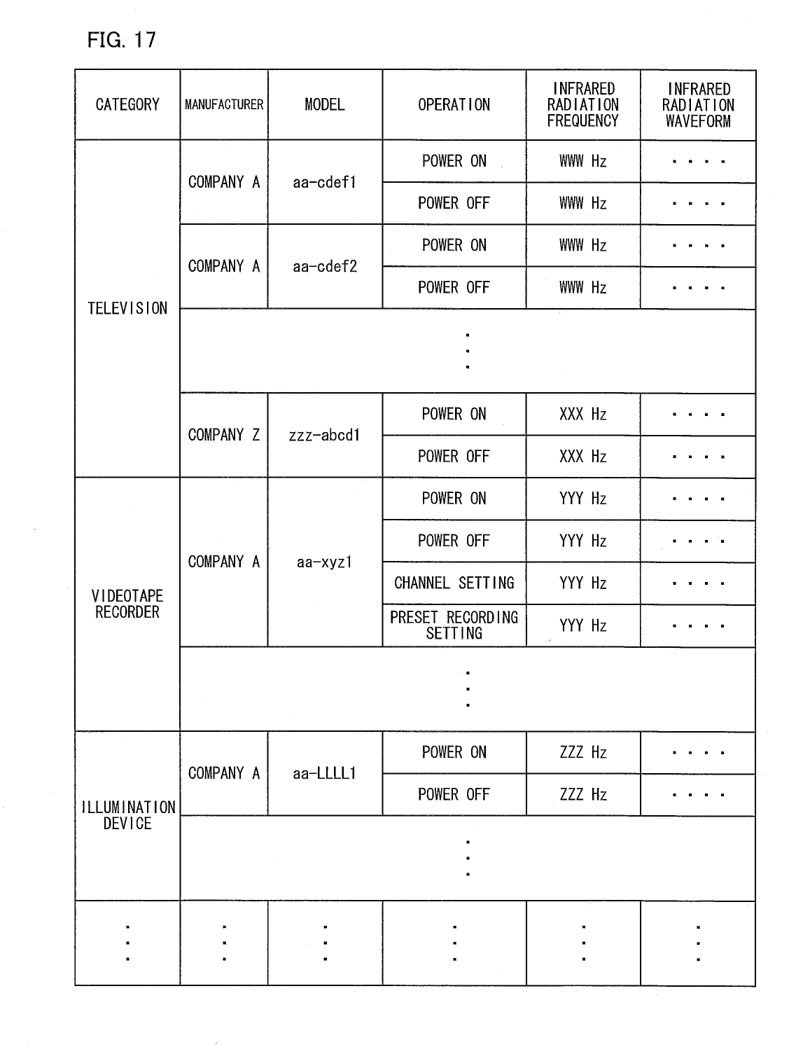

In the case where the user has selected the selection box for a category of the household electric appliance, the electronic device control application causes the display section 13 to display a list of selectable categories for the household electric appliance. Specifically, the setting information storage section 85 stores in advance, as illustrated in FIG. 17, household electric appliance information that indicates, for each of various household electric appliances, such items as (i) the category, (ii) the name of the manufacturer, (iii) the model, (iv) any operation capable of being performed with use of an infrared signal, (v) any frequency of an infrared signal for an operation of the household electric appliance, and (vi) the signal waveform of an infrared signal for any desired operation of the household electric appliance. The electronic device control application causes the display section 13 to display a list of selectable categories for the household electric appliance in the selection box for a category of the household electric appliance on the “household electric appliance registration screen” on the basis of the household electric appliance information stored in the setting information storage section 85.

The example of FIG. 16 shows (i) “television”, which is one of the selectable categories for the household electric appliance, in the selection box for a category of the household electric appliance and (ii) a display switch button (black triangle button) next to the selectable category. In the case where the user has pressed the display switch button, the electronic device control application (i) causes the display section 13 to display a list of the selectable categories for the household electric appliance and (ii) allows the user to select, from among the categories on the list, a category corresponding to the household electric appliance to be registered.

In the case where the user has selected the selection box for the model of the household electric appliance, the electronic device control application causes the display section 13 to display a list of selectable models for the household electric appliance. Specifically, the electronic device control application causes the display section 13 to display a list of selectable models for the household electric appliance in the selection box for the model of the household electric appliance on the “household electric appliance registration screen” on the basis of the household electric appliance information stored in the setting information storage section 85.

The example of FIG. 16 shows (i) “SH-AA14AZ”, which is one of the selectable models for the household electric appliance, in the selection box for the model of the household electric appliance and (ii) a display switch button (black triangle button) next to the selectable model. In the case where the user has pressed the display switch button, the electronic device control application (i) causes the display section 13 to display a list of the selectable models for the household electric appliance and (ii) allows the user to select, from among the models on the list, a model corresponding to the household electric appliance to be registered.

The information indicative of whether an icon has been set for the household electric appliance is information indicative of whether the household electric appliance is associated with an icon displayed on the icon arrangement screen.

In the case where the user has pressed the button for switching to a layout display for household electric appliances, the electronic device control application causes the display section 13 of the communication terminal device 10 to display an “icon arrangement screen” corresponding to layout information stored in the setting information storage section 85.

In the case where the user has selected on the “icon arrangement screen” an icon to be associated with the household electric appliance information to be registered, the electronic device control application associates the selected icon with the household electric appliance information being registered. The user can select an icon displayed on the “icon arrangement screen” to associate the household electric appliance information being registered with the already registered icon. Further, the user can (i) press the “Add” button displayed on the “icon arrangement screen” to add a new icon and (ii) associate the household electric appliance information being registered with the icon added.

In the case where after associating the household electric appliance information with an icon, the user has pressed the “End” button displayed on the “icon arrangement screen”, the electronic device control application (household electric appliance information editing section) edits the layout information in the setting information storage section 85 to include the association of the household electric appliance information with the icon.

In the case where the user has pressed the “Edit” button with a household electric appliance selected, the electronic device control application causes the display section 13 to display a “household electric appliance registration screen” including any update on information registered for the household electric appliance selected. The user can, through a method similar to the method for the new registration, edit as appropriate any desired item among the items registered for the household electric appliance and displayed on the “household electric appliance registration screen”.

In the case where the user has pressed the “End” button on the “household electric appliance registration screen”, the electronic device control application (household electric appliance information editing section) (i) updates information on an icon being registered which information is included in the layout information stored in the setting information storage section 85 and (ii) causes the display of the display section 13 to transition to the “outside mode setting screen”.

(1-4. “Move” Process)

The following description will discuss a process performed in the case where the user has selected “Move” on the “outside mode home screen”.

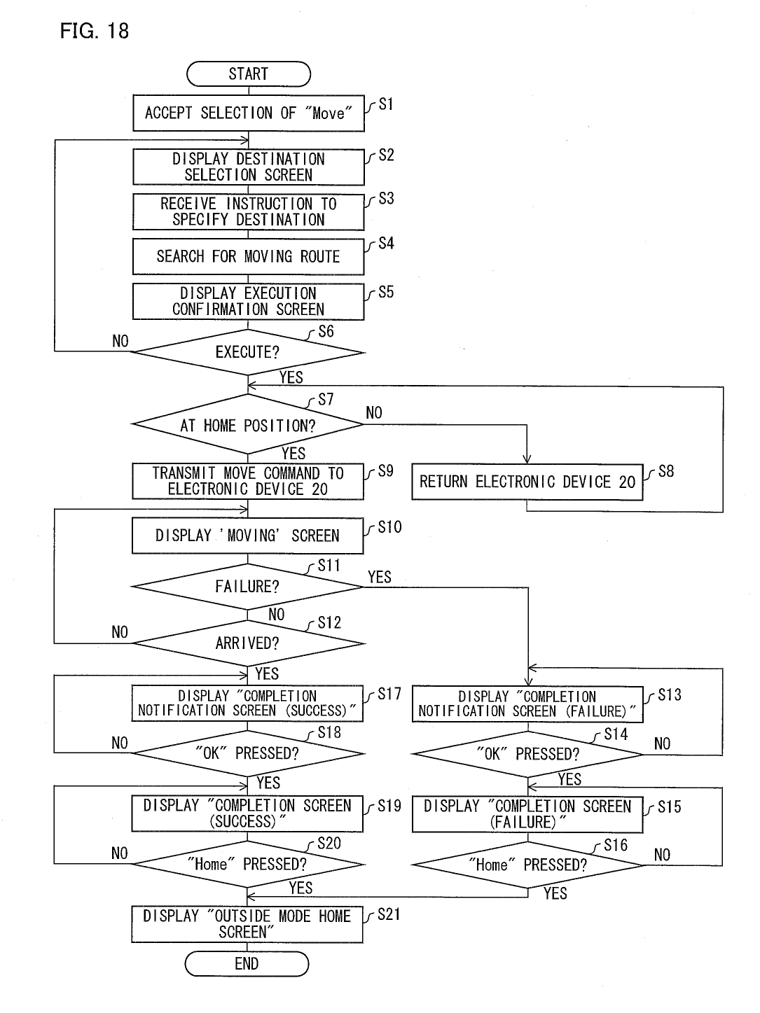

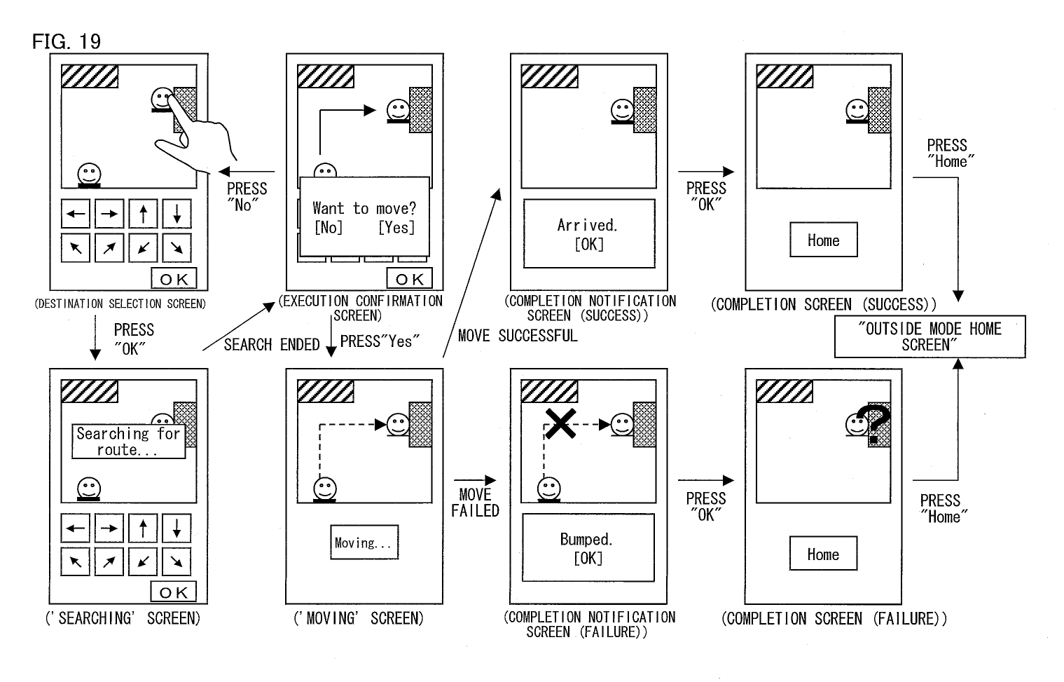

FIG. 18 is a flowchart illustrating a flow of the “Move” process performed by the electronic device control application. FIG. 19 is an explanatory diagram illustrating how the display screen displayed by the display section 13 of the communication terminal device 10 transitions during the “Move” process.

The electronic device control application, upon acceptance of selection of “Move” on the “outside mode home screen” by the user of the communication terminal device 10 (S1), (i) causes the display section 13 of the communication terminal device 10 to display a “destination selection screen” (see FIG. 19) (S2) and (ii) receives an instruction entered by the user to specify a destination (S3). The present embodiment is arranged such that (i) as illustrated in FIG. 19, the electronic device control application causes the display section 13 to display as the “destination selection screen” a layout image (that is, an image formed of an image of a layout outline and any icon over that image which icon is of a piece of furniture or a household electric appliance, for example) and that (ii) the user can specify a desired position on the layout image through a touching operation or the like and press the “OK” button to specify a destination.

The electronic device control application, upon receipt of an instruction by the user to specify a destination, searches for an optimal moving route from the home position to the destination on the basis of layout information stored in the setting information storage section 85 (S4). The electronic device control application, as illustrated in FIG. 19, causes the display section 13 to display during the search for a moving route a “‘searching’ screen”, which indicates that the electronic device control application is searching for a moving route.

The present embodiment is arranged such that the electronic device control application searches for a moving route on the basis of the following rules (1) to (5):

(1) The self-propelled electronic device 20 runs on the boundary line between adjacent running blocks on the no-running area information.

(2) The electronic device control application selects, from among different moving routes from the home position to the destination, a route involving the fewest turns.

(3) The electronic device control application selects, in the case where it has found two or more routes involving the fewest turns, a route of which the move distance from the home position to the destination is the shortest.

(4) The electronic device control application selects, in the case where it has found (i) two or more routes involving the fewest turns and (ii) two or more routes of which the move distance from the home position to the destination is the shortest, selects a route of which the minimum value of the width is the largest (that is, a route of which the minimum value of the number of running blocks present next to each other in a direction perpendicular to the direction in which the self-propelled electronic device 20 runs is the largest).

(5) The electronic device control application selects, in the case where it has found (i) two or more routes involving the fewest turns, (ii) two or more routes of which the move distance from the home position to the destination is the shortest, and (iii) two or more routes of which the minimum value of the width is the largest, either lets the user select a desired route from among those routes or selects a route through a predetermined method set in advance.

The method of searching for a moving route is not limited to the method described above, and may be any of various methods that have been publicly known. For instance, while the above method, to select a moving route, refers to different conditions in the order of priority of (i) the number of turns, (ii) the distance to be moved, and (iii) the width of the moving route, this order of priority may be changed as appropriate. Further, the searching method may refer to other conditions to select a moving route.

The electronic device control application, after completion of the search for a moving route, (i) causes the display section 13 of the communication terminal device 10 to display a moving route found and (ii) also causes the display section 13 of the communication terminal device 10 to display an “execution confirmation screen”, which asks the user to confirm whether to move the self-propelled electronic device 20 along the moving route found (see FIG. 19) (S5).

The electronic device control application determines on the basis of an instruction entered by the user on the “execution confirmation screen” whether to move the self-propelled electronic device 20 along the moving route found in S4 (S6).

In the case where the electronic device control application has determined in S6 that it will not move the self-propelled electronic device 20 (that is, in the case where the user has selected “No” on the “execution confirmation screen”), the electronic device control application returns to the step of S2. The user, in this case, specifies a destination again.

In the case where the electronic device control application has determined in S6 that it will move the self-propelled electronic device 20 (that is, in the case where the user has selected “Yes” on the “execution confirmation screen”), the electronic device control application determines whether the self-propelled electronic device 20 is at a home position (in the present embodiment, the position at which the self-propelled electronic device 20 is connected to the charging station 70) (S7). The electronic device control application may perform this determination on the basis of, for example, a signal that is transmitted from the self-propelled electronic device 20 to the server device 80 and that is indicative of whether the self-propelled electronic device 20 is connected to the charging station 70 (that is, whether the charging terminals 49 are electrically connected to the power supply terminals 71).

In the case where the electronic device control application has determined in S7 that the self-propelled electronic device 20 is not at the home position, the electronic device control application transmits a return command to the self-propelled electronic device 20 (that is, a command to cause the self-propelled electronic device 20 to return to the home position) (S8), and returns to the step of S7.

The control section 21 of the self-propelled electronic device 20, in response to the control command from the electronic device control application, controls operations of individual sections of the device function section 25 to move (return) the self-propelled electronic device 20 to the home position. The electronic device control application may, while causing the self-propelled electronic device 20 to return to the home position, cause the display section 13 of the communication terminal device 10 to display a screen indicating that the self-propelled electronic device 20 is returning to the home position.

Specifically, the present embodiment is arranged such that (i) in the case where the self-propelled electronic device 20 is separate from the charging station 70 (that is, in the case where the power supply terminals 71 are not electrically connected to the charging terminals 49), the charging station 70 constantly emits a return signal indicative of the position at which the charging station 70 is installed and the respective positions of the power supply terminals 71 and that (ii) the self-propelled electronic device 20, upon receipt of a return command from the electronic device control application, detects a return signal emitted by the charging station 70 and automatically returns to the position at which the charging station 70 is installed. While the charging station 70 of the present embodiment emits an infrared signal as the above return signal, it may alternatively use a signal other than an infrared signal.

The control section 21 of the self-propelled electronic device 20 (i) detects the position of the charging station 70 on the basis of the return signal detected and (ii) controls an operation of the move driving section 61 to cause the self-propelled electronic device 20 to travel forward (that is, travel with the front surface facing the direction of the travel) in the direction of the charging station 70 to reach a position at which the self-propelled electronic device 20 faces the charging station 70. When the self-propelled electronic device 20 has reached a position at which it faces the charging station 70, the control section 21 controls the operation of the move driving section 61 to stop the self-propelled electronic device 20 temporarily and turn the housing 30 about the center line C until the charging terminals 49 are so positioned as to face the power supply terminals 71. The control section 21 then controls the operation of the move driving section 61 to cause the housing 30 to travel backward (that is, travel with the back surface facing the direction of the travel). The control section 21 causes the self-propelled electronic device 20 to continue traveling backward until the charging terminals 49 come into contact with the power supply terminals 71 and further backward so that the power supply terminals 71, in contact with the charging terminals 49, are pushed into the charging station 70 until the self-propelled electronic device 20 reaches a docking position, at which the respective front end surfaces of the power supply terminals 71 are substantially flush with the front surface of the charging station 70 (that is, a position at which the power supply terminals 71 stop being pushed back). When the self-propelled electronic device 20 has reached the docking position, the charging station 70 starts supplying electric power to the battery 31 through the power supply terminals 71 and the charging terminals 49.

When the electric conduction detecting section 65 has detected the start of electric conduction from the charging station 70 to the battery 31, the control section 21 (i) controls the operation of the move driving section 61 to stop the self-propelled electronic device 20 from traveling backward and (ii) causes the self-propelled electronic device 20 to, with the charging terminals 49 in contact with the power supply terminals 71, rotate forward (turn clockwise) and backward (counterclockwise) about the center line C by a predetermined angle a predetermined number of times. The control section 21 further controls the electric conduction detecting section 65 to cause the electric conduction detecting section 65 to detect the amount of the electric conduction from the power supply terminals 71 to the charging terminals 49 (that is, the amount of a current from the power supply terminals 71 to the charging terminals 49 or value of a voltage applied to the charging terminals 49) during the forward and backward rotations. The control section 21 then stops the turn (forward or backward rotation) of the self-propelled electronic device 20 at a position at which the amount of the electric conduction is the largest. Alternatively, if the amount of the electric conduction is insufficient after the charging terminals 49 come into contact with the power supply terminals 71 for the first time, the control section 21 controls the operation of the move driving section 61 to cause the self-propelled electronic device 20 to (i) temporarily travel forward over a sufficient distance, for example, approximately 50 cm, and (ii) perform a series of returning steps again to dock normally at the charger 70. The distance of the temporary forward travel is not necessarily 50 cm, and may be set as appropriate in accordance with, for example, the ability to return and the method through which the housing returns. After the self-propelled electronic device 20 docks, the battery 31 is normally charged (electric conduction). This allows the battery 31 to be charged while the self-propelled electronic device 20 rests at the docking position and is oriented in a predetermined direction. The above arrangement further makes it possible to precisely adjust the orientation of the self-propelled electronic device 20 at the home position, and thus makes it possible to more precisely move the self-propelled electronic device 20 from the home position to a destination as instructed by the user.

The predetermined angle of the forward and backward rotations may be any angle within which the contact between the charging terminals 49 and the power supply terminals 71 is kept. The predetermined number of times the forward and backward rotations are performed is not limited to any particular number, and may be any number that allows the self-propelled electronic device 20 to appropriately detect a turn angle at which the amount of the electric conduction is the largest. Causing the self-propelled electronic device 20 to rotate forward and backward with the charging terminals 49 in contact with the power supply terminals 71 not only achieves the advantage of appropriately adjusting the orientation of the self-propelled electronic device 20 as described above, but also achieves the advantage of automatically removing dirt such as dust on the charging terminals 49 and the power supply terminals 71.

The method of returning the self-propelled electronic device 20 to the home position is not limited to the method described above. The method of adjusting the orientation of the self-propelled electronic device 20 at the home position is also not limited to the method described above.

The present embodiment may be arranged to, for instance, bring the charging terminals 49 into contact with the power supply terminals 71 by (i) installing a rear sensor (not shown) on a back surface (rear end) of the housing 30 and (ii) allowing the self-propelled electronic device 20 to travel backward while detecting a return signal with use of the rear sensor and adjusting its orientation. In this case, the control section 21 causes the self-propelled electronic device 20 to travel backward while the control section 21, in the case where the rear sensor has started to detect no return signal, causes the self-propelled electronic device 20 to rotate forward or backward about the center line C of the housing 30 by a small amount to adjust the orientation of the self-propelled electronic device 20 for detection of a return signal. This makes it possible to appropriately (i) align the charging terminals 49 of the self-propelled electronic device 20 with the power supply terminals 71 of the charging station 70 and (ii) adjust the orientation of the self-propelled electronic device 20.

In the case where the electronic device control application has determined in S7 that the self-propelled electronic device 20 is at the home position, the electronic device control application (i) generates a move command for causing the self-propelled electronic device 20 to move along the moving route found in S4 and (ii) transmits the move command to the self-propelled electronic device 20 (S9).

The move command may be, for example, a combination of (i) the distance over which to cause the self-propelled electronic device 20 to travel forward and (ii) the direction to which to cause the self-propelled electronic device 20 to turn (that is, a 90-degree forward rotation or 90-degree backward rotation), as in “N-cm forward travel”->“90-degree forward rotation”->“M-cm forward travel”. The present embodiment is, as described above, arranged such that the charging station 70 is installed at a fixed position as the home position and that the self-propelled electronic device 20 returns to the home position in a precisely adjusted orientation. With this arrangement, moving the self-propelled electronic device 20 with use of a simple move command such as the above can still move the self-propelled electronic device 20 to a destination precisely.

The electronic device control application, after S9, causes the display section 13 of the communication terminal device 10 to display a “‘moving’ screen”, which indicates that the self-propelled electronic device 20 is moving (S10). The electronic device control application may, for instance, cause a portion of the display screen which portion indicates the moving route to blink on the “‘moving’ screen” to indicate that the self-propelled electronic device 20 is moving.

The electronic device control application may, after it has determined in S6 that it will move the self-propelled electronic device 20, cause the display section 13 to display a “‘moving’screen” also while causing the self-propelled electronic device to return. Alternatively, the electronic device control application may, (i) while causing the self-propelled electronic device 20 to return to the home position, cause the display section 13 to display a screen indicating that the self-propelled electronic device 20 is returning to the home position and (ii) cause the display section 13 to display a “‘moving’ screen” after completion of the return of the self-propelled electronic device 20.

The electronic device control application, after it has started to move the self-propelled electronic device 20, determines (i) whether it has received a move failure notification from the self-propelled electronic device 20 (S11) and (ii) whether it has received a move completion notification (S12). The self-propelled electronic device 20, upon receipt of a move command from the electronic device control application, moves in response to that move command. The self-propelled electronic device 20 then, in the case where it has arrived at the destination, transmits a move completion notification to the electronic device control application (server device 80) and in the case where it has failed to arrive at the destination (for example, in the case where it has bumped on an obstruction before arriving at the destination and become unable to continue moving), transmits a move failure notification to the electronic device control application (server device 80).

In the case where the electronic device control application has determined in S11 that it has received a move failure notification, the electronic device control application causes the display section 13 to display a “completion notification screen (failure)” (see FIG. 19) (S13). The electronic device control application then determines whether the user has pressed the “OK” button on the “completion notification screen (failure)” (S14). In the case where the electronic device control application has determined in S14 that the user did not press the “OK” button, the electronic device control application continues the step of S13. In the case where the electronic device control application has determined in S14 that the user has pressed the “OK” button, the electronic device control application causes the display section 13 to display a “completion screen (failure)” (see FIG. 19) (S15). The electronic device control application then determines whether the user has pressed the “Home” button on the “completion screen (failure)” (S16). In the case where the electronic device control application has determined in S16 that the user did not press the “Home” button, the electronic device control application continues the step of S15. In the case where the electronic device control application has determined in S16 that the user has pressed the “Home” button, the electronic device control application causes the display section 13 to display the “outside mode home screen” (S21) and ends the “Move” process.

In the case where the electronic device control application has determined in S12 that it has received a move completion notification, the electronic device control application causes the display section 13 to display a “completion notification screen (success)” (see FIG. 19) (S17). The electronic device control application then determines whether the user has pressed the “OK” button on the “completion notification screen (success)” (S18). In the case where the electronic device control application has determined in S18 that the user did not press the “OK” button, the electronic device control application continues the step of S17.

In the case where the electronic device control application has determined in S18 that the user has pressed the “OK” button, the electronic device control application causes the display section 13 to display a “completion screen (success)” (see FIG. 19) (S19). The electronic device control application then determines whether the user has pressed the “Home” button on the “completion screen (success)” (S20). In the case where the electronic device control application has determined in S20 that the user did not press the “Home” button, the electronic device control application continues the step of S19. In the case where the electronic device control application has determined in S20 that the user has pressed the “Home” button, the electronic device control application causes the display section 13 to display the “outside mode home screen” (S21) and end the “Move” process.

(1-5. “Home Electric Appliance” Process)

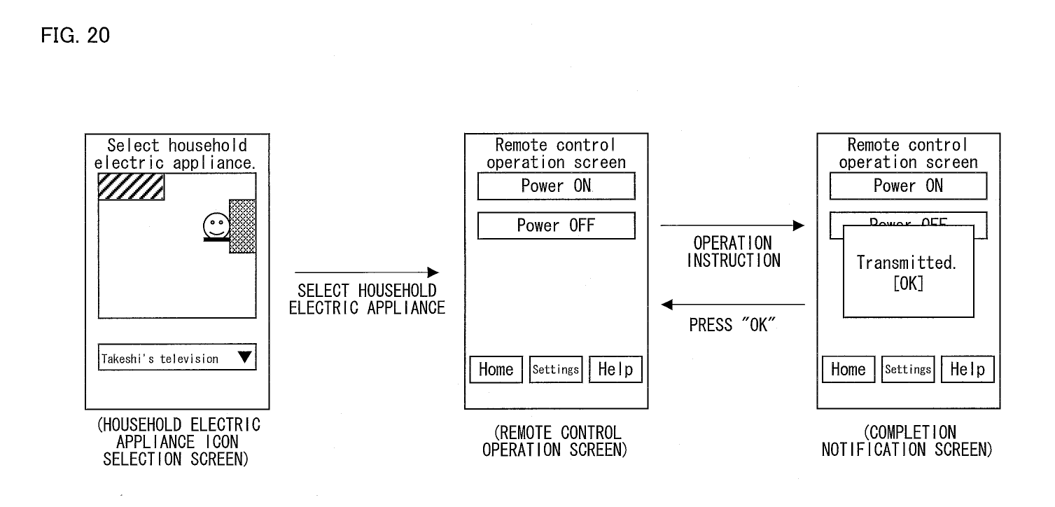

The following description will discuss a process performed in the case where the user has selected “Household electric appliance” on the “outside mode home screen”. FIG. 20 is an explanatory diagram illustrating how the display screen displayed by the display section 13 of the communication terminal device 10 transitions during the “Household electric appliance” process.

In the case where the user has selected “Household electric appliance” on the “outside mode home screen”, the electronic device control application causes the display section 13 of the communication terminal device 10 to display a “household electric appliance icon selection screen” (see FIG. 20).

The “household electric appliance icon selection screen” shows a layout image (that is, an image formed of an image corresponding to layout outline information and any icon over that image which image has been registered in the setting information). The user can select the icon of a household electric appliance as an operation target to select a household electric appliance to be operated.

The “household electric appliance icon selection screen” shows a menu image for the user to select a household electric appliance as an operation target from among the household electric appliances registered in the setting information. The user can thus select a household electric appliance as an operation target also from the menu image. The example of FIG. 20 shows (i) the name of one of the registered household electric appliances (“Takeshi's television”) and (ii) a display switch button (black triangle button) next to that name. In the case where the user has pressed the display switch button, the electronic device control application (i) causes the display section 13 to display the list of the registered household electric appliances and (ii) allows the user to select a desired household electric appliance from among the registered household electric appliances on the list.

In the case where the user has selected a household electric appliance as an operation target on the “household electric appliance icon selection screen”, the electronic device control application (i) generates, on the basis of setting information (see FIG. 17) on the household electric appliance which setting information is stored in the setting information storage section 85, a “remote control operation screen” (see FIG. 20), which allows the user to operate the household electric appliance, and (ii) causes the display section 13 of the communication terminal device 10 to display the “remote control operation screen”. The example of FIG. 20 illustrates a “remote control operation screen” for the user to select either “power supply ON” or “power supply OFF” as an operation content.

In the case where the user has entered an instruction on the “remote control operation screen” to select an operation for the household electric appliance as an operation target, the electronic device control application (i) generates, on the basis of setting information (see FIG. 17) on the household electric appliance which setting information is stored in the setting information storage section 85, a control signal for causing the household electric appliance to perform the operation responding to the user's instruction (that is, a signal for causing the self-propelled electronic device 20 to generate an infrared signal [remote control signal] to be transmitted to the household electric appliance) and (ii) transmits the control signal to the self-propelled electronic device 20.

The control section 21 of the self-propelled electronic device 20 (i) generates an infrared signal (remote control signal) on the basis of the control signal transmitted from the electronic device control application and (ii) outputs (transmits) the infrared signal from the infrared transmitting section 36 to the household electric appliance as an operation target. The control section 21 of the self-propelled electronic device 20, after completion of the output (transmission) of an infrared signal (remote control signal), transmits a transmission completion notification to the electronic device control application (server device 80).

The electronic device control application, upon receipt of a transmission completion notification from the self-propelled electronic device 20, causes the display section 13 of the communication terminal device 10 to display a “completion notification screen” (see FIG. 20) and end the “Household electric appliance” process.

The present embodiment is arranged such that in the case where the user has selected “Household electric appliance” on the “outside mode home screen”, the self-propelled electronic device 20, at its current position, outputs an infrared signal for operating the household electric appliance selected.

Thus, in the case where, for instance, the user wants to operate a household electric appliance that is difficult to operate with use of an infrared signal from the home position, the user first selects the “Move” operation to move the self-propelled electronic device 20 to an appropriate position and then selects the “Household electric appliance” operation.

The present invention is, however, not limited to such an arrangement, and may alternatively be arranged, for instance, such that (i) in the case where the user has specified a household electric appliance as an operation target through a “Household electric appliance” operation, the electronic device control application determines, on the basis of the positional relationship between the self-propelled electronic device 20 and that household electric appliance as an operation target, whether the electronic device control application needs to move the self-propelled electronic device 20 and (ii) in the case where the electronic device control application has determined that the electronic device control application needs to move the self-propelled electronic device 20, the electronic device control application automatically moves the self-propelled electronic device 20 to a position at which the self-propelled electronic device 20 is able to control an operation of the household electric appliance as an operation target with use of an infrared signal.

(1-6. “Observe” Operation)

The following description will discuss a process performed in the case where the user has selected “Observe” on the “outside mode home screen”.

In the case where the user has selected “Observe” on the “outside mode home screen”, the electronic device control application transmits to the self-propelled electronic device 20 a command to start an image capturing process.

The control section 21 of the self-propelled electronic device 20, upon receipt of a command to start an image capturing process, (i) controls an operation of the image capturing section 40 to cause the image capturing section 40 to capture an image of the surroundings of the self-propelled electronic device 20 and (ii) transmits data on the captured image to the electronic device control application in response to the command. The control section 21 of the self-propelled electronic device 20 may control the move driving section 61 to, for example, turn the self-propelled electronic device 20 to allow the self-propelled electronic device 20 to capture an image from a plurality of directions or from a wide range of angles.

The electronic device control application, upon receipt of the data on the captured image from the self-propelled electronic device 20, causes the display section 13 of the communication terminal device 10 to display the received captured-image data to present the captured-image data to the user.

The present embodiment is arranged such that in the case where the user has selected “Observe” on the “outside mode home screen”, the electronic device control application causes the self-propelled electronic device 20 to perform an image capturing process at its current position. Thus, in the case where, for instance, the user wants an image to be captured at a position away from the home position, the user first selects the “Move” operation to move the self-propelled electronic device 20 to a desired position and then selects the “Observe” operation. The present invention is, however, not limited to such an arrangement, and may alternatively be arranged, for instance, such that (i) the user specifies an observation target area through an “Observe” operation and (ii) the electronic device control application automatically moves the self-propelled electronic device 20 to a position suitable for observation of that target area.

(1-7. “Clean Up” Operation)

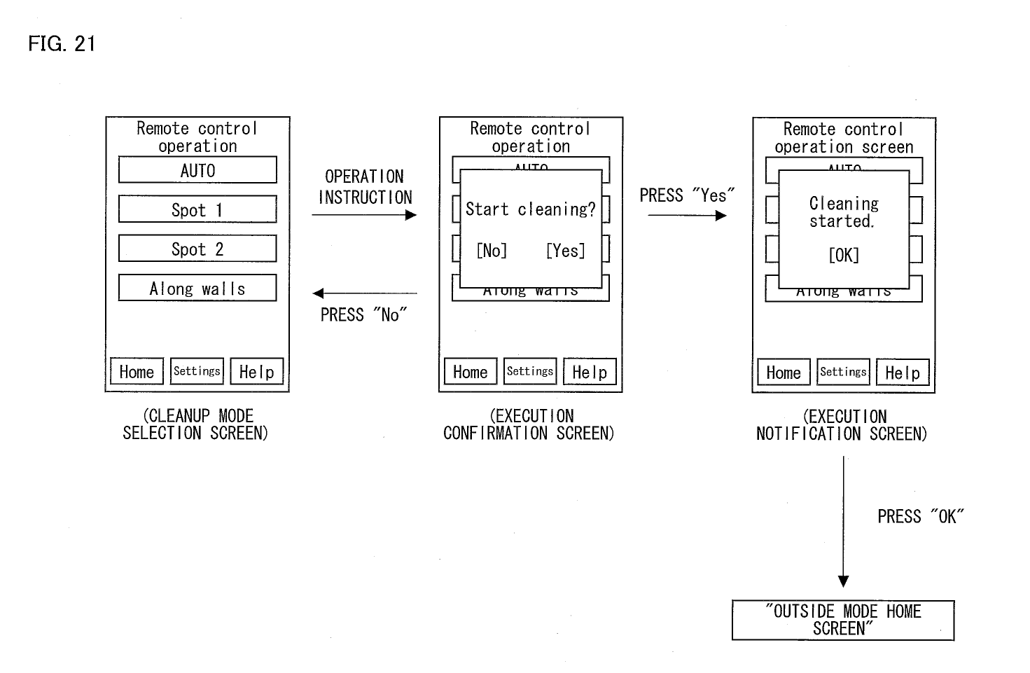

The following description will discuss a process performed in the case where the user has selected “Clean up” on the “outside mode home screen”. FIG. 21 is an explanatory diagram illustrating how the display screen displayed by the display section 13 of the communication terminal device 10 transitions during the “Clean up” process.

In the case where the user has selected “Clean up” on the “outside mode home screen”, the electronic device control application causes the display section 13 of the communication terminal device 10 to display a “cleanup mode selection screen” (see FIG. 21).

The “cleanup mode selection screen” shows an image for the user to select a desired cleanup mode from among a plurality of preset cleanup modes. The example of FIG. 21 selectably shows the cleanup modes “AUTO”, “Spot 1”, “Spot 2”, and “Along walls”. The “AUTO” cleanup mode causes the self-propelled electronic device 20 to perform cleaning while running randomly. The “Spot 1” and “Spot 2” cleanup modes each cause the self-propelled electronic device 20 to perform cleaning within a preset cleaning region. The “Along walls” cleanup mode causes the self-propelled electronic device 20 to perform cleaning while moving along an obstruction such as a wall.

In the case where the user has selected a cleanup mode on the “cleanup mode selection screen”, the electronic device control application causes the display section 13 of the communication terminal device 10 to display an “execution confirmation screen” (see FIG. 21).

In the case where the user has selected “No” on the “execution confirmation screen”, the electronic device control application causes the display section 13 of the communication terminal device 10 to switch the display screen back to the “cleanup mode selection screen”.

In the case where the user has selected “Yes” on the “execution confirmation screen”, the electronic device control application causes the display section 13 of the communication terminal device 10 to display an “execution notification screen” (see FIG. 21). In the case where the user has then pressed “OK” on the “execution notification screen”, the electronic device control application causes the display section 13 of the communication terminal device 10 to display the “outside mode home screen” and end the process for the “Clean up” operation.

(1-8. “Return” Operation)

The following description will discuss a process performed in the case where the user has selected “Return” on the “outside mode home screen”.

In the case where the user has selected “Return” on the “outside mode home screen”, the electronic device control application transmits a return command to the self-propelled electronic device 20.

The control section 21 of the self-propelled electronic device 20, upon receipt of a return command, performs a return process of causing the self-propelled electronic device 20 to move (return) to a home position (in the present embodiment, the position at which the charging terminals 49 of the self-propelled electronic device 20 are in contact with the power supply terminals 71 of the charging station 70 so that the battery 31 of the self-propelled electronic device 20 is charged). The control section 21 performs the return process through the method described above.

The electronic device control application may, during a return process, cause the display section 13 of the communication terminal device 10 to display an image indicating that a return process is being performed. Further, the present embodiment may be arranged such that upon completion of a return process, (i) the self-propelled electronic device 20 transmits a return process completion notification to the electronic device control application (server device 80) and (ii) the electronic device control application then causes the display section 13 of the communication terminal device 10 to display an image indicative of the completion of the return process or an image indicating that the self-propelled electronic device 20 is at the home position.

(1-9. Program Examples)

In the present embodiment, each block of the communication terminal device 10, the self-propelled electronic device 20, and the server device 80 (in particular, the control section 11, the control section 21, and the control section 81) can be implemented by means of hardware with use of a logic circuit formed on an integrated circuit (IC chip) or by means of software with use of a central processing unit (CPU).

In the case where each block is implemented by means of software, the communication terminal device 10, the self-propelled electronic device 20, and the server device 80 each include a CPU and memory devices (memory media). The CPU executes instructions in control programs realizing the functions. The memory devices include a read only memory (ROM) which contains programs, a random access memory (RAM) to which the programs are loaded, and a memory containing the programs and various data. The object of the present invention can also be achieved by mounting to each of the communication terminal device 10, the self-propelled electronic device 20, and the server device 80 a computer-readable storage medium containing control program code (executable program, intermediate code program, or source program) for the communication terminal device 10, the self-propelled electronic device 20, and the server device 80, which is software realizing the aforementioned functions, in order for the computer (or CPU, MPU) to retrieve and execute the program code contained in the storage medium.

The storage medium may be a non-transitory tangible medium, for example, a tape such as a magnetic tape or cassette tape; a magnetic disk such as a floppy (registered trademark) disk or hard disk, or an optical disk such as a CD-ROM, MO, MD, DVD, or CD-R; a card such as an IC card (memory card) or optical card; a semiconductor memory such as a mask ROM, EPROM, EEPROM (registered trademark), or flash ROM; or a logic circuit such as a programmable logic device (PLD) or field programmable gate array (FPGA).

The communication terminal device 10, the self-propelled electronic device 20, and the server device 80 may each be arranged to be connectable to a communications network so that the program code may be delivered over the communications network. The communications network is not limited in any particular manner as long as it allows transmission of program code, and may be, for example, the Internet, an intranet, extranet, LAN, ISDN, VAN, CATV communications network, virtual dedicated network, telephone line network, mobile communications network, or satellite communications network. The transfer medium which makes up the communications network is not limited to any particular arrangement or kind as long as it allows transmission of program code, and may be, for example, wired line such as IEEE 1394, USB, electric power line, cable TV line, telephone line, or asynchronous digital subscriber loop (ADSL) line; or wireless, such as infrared radiation (IrDA, remote control), Bluetooth (registered trademark), 802.11 wireless, high data rate (HDR), near field communication (NFC), digital living network alliance (DLNA), mobile telephone network, satellite line, or terrestrial digital network.

(1-10. Recap of Embodiment 1)

As described above, a household electric appliance operation system according to one mode of the present invention is a household electric appliance operation system including an operation signal transmitting section for transmitting, to a plurality of household electric appliances, an operation signal for controlling respective operations of the household electric appliances, the household electric appliance operation system including: a display section for displaying a layout image including (i) a layout outline image indicative of a shape of a region in which the operation signal transmitting section is present and (ii) at least one icon over the layout outline image which icon is of a household electric appliance present in the region; a storage section storing household electric appliance information indicative of an association, with one another, of (i) the at least one icon of the household electric appliance, (ii) one or more operation contents that the household electric appliance is capable of being instructed to perform, and (iii) operation signal information indicative of an operation signal for instructing the household electric appliance to perform an operation corresponding to the one or more operation contents; an instruction input section for receiving from a user (i) a selection instruction to select a household electric appliance as an operation target from among the at least one icon included in the layout image and (ii) an operation instruction to specify an operation content for the selected household electric appliance; and an operation signal generating section for generating the operation signal, indicated in the operation signal information, on a basis of (i) the household electric appliance information stored in the storage section and (ii) the selection instruction and the operation instruction both of which have been received by the instruction input section, the operation signal transmitting section transmitting the operation signal generated by the operation signal generating section.

With the above arrangement, the display section displays a layout image including (i) a layout outline image indicative of the shape of a region in which the operation signal transmitting section is present and (ii) at least one icon over the layout outline image which icon is of a household electric appliance present in the region. Further, in the case where the instruction input section has received from the user a selection instruction to select a household electric appliance as an operation target from among the icons included in the layout image and an operation instruction to specify an operation content for the selected household electric appliance, (i) the operation signal generating section generates, on the basis of household electric appliance information stored in the storage section and the selection instruction and operation instruction received by the instruction input section, an operation signal for instructing the household electric appliance selected by the user to perform the operation content specified by the user, and (ii) the operation signal transmitting section transmits the operation signal generated by the operation signal generating section. The above arrangement allows the user to simply (i) select an icon for the operation target from among icons included in the layout image and (ii) specify an operation content for automatic generation and transmission of an operation signal for operating, in correspondence with the operation content specified by the user, the household electric appliance corresponding to the icon selected by the user. This can improve usability.

The household electric appliance operation system may be arranged such that the storage section further stores registered reference information indicative of an association, with one another, of (i) respective model names of a plurality of household electric appliances, (ii) operation contents for the household electric appliances, and (iii) the operation signal information; and the household electric appliance operation system further includes a household electric appliance information editing section for editing the household electric appliance information on a basis of a piece of the registered reference information which piece has been selected by the user. The edition includes (i) a process of newly registering household electric appliance information for a new household electric appliance and (ii) a process of changing all or part of household electric appliance information already registered.

The above arrangement allows the user to simply select the icon of a household electric appliance as an edition target and its model name to edit (i) the icon of the household electric appliance, (ii) one or more operation contents that the household electric appliance is capable of being instructed to perform, and (iii) operation signal information indicative of an operation signal for instructing the household electric appliance to perform an operation corresponding to the one or more operation contents. This can further improve usability.

The household electric appliance operation system may be arranged such that in a case where the instruction input section has received from the user a selection instruction to select a household electric appliance as an operation target from among the at least one icon included in the layout image, the display section displays operation contents that are associated with the selected household electric appliance in the household electric appliance information and that the selected household electric appliance is capable of being instructed to perform; and the instruction input section receives as the operation instruction an instruction by the user to select, from among the operation contents that the display section displays, an operation content for the selected household electric appliance corresponding to the selection instruction.

With the above arrangement, in the case where the user has selected a household electric appliance as an operation target on the layout image, the display section displays operation contents that the selected household electric appliance is capable of being instructed to perform, so that the user can select a desired operation content from among the operation contents displayed. The above arrangement thus allows the user to easily (i) learn the operation contents that the selected household electric appliance is capable of being instructed to perform and (ii) select a desired operation content. This can improve usability even further.

The household electric appliance operation system may further include: a self-propelled electronic device; and a communication terminal device for instructing, over a communication network, the self-propelled electronic device to operate, wherein: the operation signal transmitting section is included in the self-propelled electronic device; and the display section and the instruction input section are included in the communication terminal device.

With the above arrangement, the user can provide an operation instruction from the communication terminal device over a communication network to the self-propelled electronic device to cause the operation signal transmitting section of the self-propelled electronic device to transmit an operation signal for operation of a household electric appliance. The above arrangement thus allows the user to, for example, operate an household electric appliance from a place away from home or a remote place. This can further improve usability.

The household electric appliance operation system may be arranged such that the operation signal information indicates a frequency and signal waveform of the operation signal.

The above arrangement makes it possible to generate, on the basis of the operation signal information, an operation signal suitable for a household electric appliance as an operation target.

A household electric appliance operation method according to one mode of the present invention is a household electric appliance operation method for use in a household electric appliance operation system including an operation signal transmitting section for transmitting, to a plurality of household electric appliances, an operation signal for controlling respective operations of the household electric appliances, the household electric appliance operation method including the steps of: (a) displaying a layout image including (i) a layout outline image indicative of a shape of a region in which the operation signal transmitting section is present and (ii) at least one icon over the layout outline image which icon is of a household electric appliance present in the region; (b) causing a storage section to store, in advance, household electric appliance information indicative of an association, with one another, of (i) the at least one icon of the household electric appliance, (ii) one or more operation contents that the household electric appliance is capable of being instructed to perform, and (iii) operation signal information indicative of an operation signal for instructing the household electric appliance to perform an operation corresponding to the one or more operation contents; (c) receiving from a user (i) a selection instruction to select a household electric appliance as an operation target from among the at least one icon included in the layout image and (ii) an operation instruction to specify an operation content for the selected household electric appliance; (d) generating, on a basis of (i) the household electric appliance information stored in the storage section and (ii) the selection instruction and the operation instruction both of which have been received in the step (c), an operation signal for instructing the household electric appliance, selected by the user, to perform the operation content specified by the user; and (e) transmitting, from the operation signal transmitting section, the operation signal generated in the step (d).

With the above method, a layout image is displayed which includes (i) a layout outline image indicative of the shape of a region in which the operation signal transmitting section is present and (ii) at least one icon over the layout outline image which icon is of a household electric appliance present in the region. Further, in the case where (i) a selection instruction to select a household electric appliance as an operation target from among the at least one icon included in the layout image and (ii) an operation instruction to specify an operation content for the selected household electric appliance have been received from the user, the method (i) generates, on the basis of household electric appliance information stored in advance in the storage section to indicate an association, with one another, of the at least one icon of the household electric appliance, one or more operation contents that the household electric appliance is capable of being instructed to perform, and operation signal information indicative of an operation signal for instructing the household electric appliance to perform an operation corresponding to the one or more operation contents, and the selection instruction and operation instruction, an operation signal for instructing the household electric appliance selected by the user to perform the operation content specified by the user, and (ii) transmits, from the operation signal transmitting section, the operation signal generated. The above arrangement allows the user to simply (i) select an icon for the operation target from among icons included in the layout image and (ii) specify an operation content, for automatic generation and transmission of an operation signal for operating, in correspondence with the operation content specified by the user, the household electric appliance corresponding to the icon selected by the user. This can improve usability.

A self-propelled electronic device according to one mode of the present invention is a self-propelled electronic device capable of transmitting, to a plurality of household electric appliances, an operation signal for controlling respective operations of the household electric appliances, the self-propelled electronic device including: a communication section for receiving, from another device over a communication network, operation signal information indicative of an operation signal for instructing a household electric appliance, selected by a user, to perform an operation corresponding to an operation content specified by the user; an operation signal generating section for generating the operation signal on a basis of the operation signal information; and an operation signal transmitting section for transmitting the operation signal generated by the operation signal generating section.

With the above arrangement, in the case where the communication section has received, from another device over a communication network, operation signal information indicative of an operation signal for instructing a household electric appliance, selected by a user, to perform an operation corresponding to an operation content specified by the user, (i) the operation signal generating section generates the operation signal on the basis of the operation signal information, and (ii) the operation signal transmitting section transmits the operation signal. The above arrangement thus allows the user to simply select a household electric appliance as an operation target and an operation content for the household electric appliance to automatically cause the self-propelled electronic device to generate and transmit an operation signal for operating the household electric appliance, selected by the user, in correspondence with the operation content specified by the user. This can improve usability.

A layout information creating device according to one mode of the present invention is a layout information creating device for use (i) in an electronic device controlling system for instructing, over a communication network, a self-propelled electronic device to operate and (ii) to create layout information for a region in which the self-propelled electronic device is present, the layout information including: arrangement information indicative of a type and placement position of an object placed in the region; and no-running area information for classifying the region into (i) a running area in which the self-propelled electronic device is able to run and (ii) a no-running area in which the self-propelled electronic device is unable to run, the layout information creating device including: a storage section storing, in association with each other, (i) an icon of the placed object and (ii) a no-running range in which the self-propelled electronic device is unable to run due to the placed object indicated by the icon; and a control section for creating the layout information on a basis of (i) a placement position of an icon which placement position has been specified by a user and (ii) a no-running range stored in association the selected icon.

With the above arrangement, the storage section stores placed-object information indicative of the association, for each object, of (i) the icon of the object with (ii) a no-running range in which in the case where the object indicated by the icon is placed in the region in which the self-propelled electronic device is present, the self-propelled electronic device is unable to run due to the placed object. In the case where the user has entered an instruction to specify a placement position for an icon, the control section generates the layout information on the basis of (i) the placement position for the icon which placement position has been specified by the user and (ii) a no-running range stored in association with the icon. The above arrangement thus allows the user to simply specify a placement position for the icon indicative of an object to automatically create layout information. The above arrangement consequently makes it possible to easily create layout information.

The layout information creating device may be arranged such that the control section has a function of, in response to an instruction by the user, changing the no-running range stored in the storage section in association with the icon of the placed object.

The above arrangement allows the user to appropriately change (edit) a no-running range that is included in the placed-object information stored in the storage section and that corresponds to at least one placed object. The above arrangement thus allows the user to appropriately edit, in correspondence with the shape, placement position, placement state and the like of an object actually placed in the region in which the self-propelled electronic device is present, a no-running range for that object placed in the region. The above arrangement consequently makes it possible to create layout information more faithful to the actual placement state.

The layout information creating device may be arranged such that the control section has a function of, in response to an instruction by the user, toggling whether a range indicated in the no-running area information stored in the storage section belongs to a running area or a no-running area.

The above arrangement makes it possible to, in response to an instruction by the user, toggling whether a range indicated in the no-running area information stored in the storage section belongs to a running area or a no-running area. The above arrangement thus allows the user to appropriately edit no-running areas and running areas in correspondence with the actual situation of the region in which the self-propelled electronic device is present. The above arrangement consequently makes it possible to generate layout information more faithful to the actual situation. Further, the above arrangement allows the user to set any range to a no-running area, and thus allows the user to set, to a no-running area, a region in which, for example, the user does not want the self-propelled electronic device to run.

The layout information creating device may be arranged such that the control section generates the no-running area information by dividing the region into a plurality of blocks in a matrix and classifying the blocks into (i) a running block in which the self-propelled electronic device is able to run and (ii) a no-running block in which the self-propelled electronic device is unable to run.

The above arrangement makes it possible to easily manage the no-running areas and running areas. The above arrangement further makes it possible to, in the case where the self-propelled electronic device is to be moved on the basis of the no-running area information created, easily select a moving route for the self-propelled electronic device.

The layout information creating device may be arranged such that a portion of the placed-object information stored in the storage section which portion is on an object installed at such a position as not to prevent the self-propelled electronic device from running is set so as to indicate an absence of a no-running range.

With the above arrangement, placed-object information on an object installed at such a position as not to prevent the self-propelled electronic device from running (for example, the ceiling or wall surface) can be set so as to indicate the absence of a no-running range. The above arrangement thus makes it possible to create layout information more faithful to the actual placement state.

The layout information creating device may be included in the communication terminal device or the self-propelled electronic device, or may be provided separately from the communication terminal device or the self-propelled electronic device. In the case where the layout information creating device is provided separately from the communication terminal device or the self-propelled electronic device, the layout information creating device may be connected communicably to at least one of the communication terminal device and the self-propelled electronic device. Further, the layout information created by the layout information creating device may be stored on any of various recording mediums so that the layout information stored on the recording medium is readable by the communication terminal device, the self-propelled electronic device, or a device communicable with at least one of the communication terminal device and the self-propelled electronic device.

A layout information generating method according to one mode of the present invention is a layout information generating method for use (i) in an electronic device controlling system for instructing, over a communication network, a self-propelled electronic device to operate and (ii) to create layout information for a region in which the self-propelled electronic device is present, the layout information including: arrangement information indicative of a type and placement position of an object placed in the region; and no-running area information for classifying the region into (i) a running area in which the self-propelled electronic device is able to run and (ii) a no-running area in which the self-propelled electronic device is unable to run, the layout information generating method including the steps of: causing a storage section to store, in association with each other, (i) an icon of the placed object and (ii) a no-running range in which the self-propelled electronic device is unable to run due to the placed object indicated by the icon; and a computer creating the layout information on a basis of (i) a placement position of an icon selected by a user and (ii) a no-running range stored in association the selected icon.

The above method causes a storage section to store placed-object information indicative of the association, for each object, of (i) the icon of the object with (ii) a no-running range in which in the case where the object indicated by the icon is placed in the region in which the self-propelled electronic device is present, the self-propelled electronic device is unable to run due to the placed object. In the case where the user has entered an instruction to specify a placement position for an icon, a computer generates the layout information on the basis of (i) the placement position for the icon which placement position has been specified by the user and (ii) a no-running range stored in association with the icon. The above method thus allows the user to simply specify a placement position for the icon indicative of an object to automatically create layout information. The above method consequently makes it possible to easily create layout information.

A self-propelled electronic device according to one mode of the present invention is a self-propelled electronic device for (i) receiving, over a communication network, an operation instruction generated on a basis of layout information created by the layout information creating device according and (ii) operating on a basis of the operation instruction received.

The above arrangement allows the user to simply specify a placement position for the icon indicative of an object to automatically create layout information. The above arrangement thus allows the user to cause the self-propelled electronic device to operate in response to an operation instruction generated on the basis of the layout information created.

The household electric appliance operation system and/or the self-propelled electronic device may be in the form of a computer. In this case, the present invention further includes in its scope (i) a program for causing a computer to operate as the operation signal generating section and/or the household electric appliance information editing section to cause the computer to function as the household electric appliance operation system and/or the self-propelled electronic device and (ii) a computer-readable recording medium on which that program is stored.

The present invention is not limited to the description of the embodiment above, but may be altered in various ways by a skilled person within the scope of the claims. Any embodiment based on a proper combination of technical means modified appropriately without departing from the scope of the present invention is encompassed in the technical scope of the present invention.

### INDUSTRIAL APPLICABILITY

The present invention is applicable to a household electric appliance operation system and a self-propelled electronic device each having a function of operating a plurality of household electric appliances.

### REFERENCE SIGNS LIST

10 communication terminal device
11 control section
12 communication section
13 display section
14 operation section
15 storage section
20 self-propelled electronic device
21 control section (operation signal generating section)
22 communication section
23 operation section
24 storage section
25 device function section
36 infrared transmitting section (operation signal transmitting section)
49 charging terminal
70 charging station
71 power supply terminal
80 server device (layout information creating device)
81 control section (household electric appliance information editing section)
82 communication section
83 storage section
84 electronic device control application storage section
85 setting information storage section
90 communication network
100 electronic device controlling system

1. A household electric appliance operation system including an operation signal transmitting section for transmitting, to a plurality of household electric appliances, an operation signal for controlling respective operations of the household electric appliances,
the household electric appliance operation system comprising:
a display section for displaying a layout image including (i) a layout outline image indicative of a shape of a region in which the operation signal transmitting section is present and (ii) at least one icon over the layout outline image which icon is of a household electric appliance present in the region;
a storage section storing household electric appliance information indicative of an association, with one another, of (i) the at least one icon of the household electric appliance, (ii) one or more operation contents that the household electric appliance is capable of being instructed to perform, and (iii) operation signal information indicative of an operation signal for instructing the household electric appliance to perform an operation corresponding to the one or more operation contents;
an instruction input section for receiving from a user (i) a selection instruction to select a household electric appliance as an operation target from among the at least one icon included in the layout image and (ii) an operation instruction to specify an operation content for the selected household electric appliance; and
an operation signal generating section for generating the operation signal, indicated in the operation signal information, on a basis of (i) the household electric appliance information stored in the storage section and (ii) the selection instruction and the operation instruction both of which have been received by the instruction input section,
the operation signal transmitting section transmitting the operation signal generated by the operation signal generating section.

2. The household electric appliance operation system according to claim 1,
wherein:
the storage section further stores registered reference information indicative of an association, with one another, of (i) respective model names of a plurality of household electric appliances, (ii) operation contents for the household electric appliances, and (iii) the operation signal information; and
the household electric appliance operation system further comprises a household electric appliance information editing section for editing the household electric appliance information on a basis of a piece of the registered reference information which piece has been selected by the user.

3. The household electric appliance operation system according to claim 1,
wherein:
in a case where the instruction input section has received from the user a selection instruction to select a household electric appliance as an operation target from among the at least one icon included in the layout image, the display section displays operation contents that are associated with the selected household electric appliance in the household electric appliance information and that the selected household electric appliance is capable of being instructed to perform; and
the instruction input section receives as the operation instruction an instruction by the user to select, from among the operation contents that the display section displays, an operation content for the selected household electric appliance corresponding to the selection instruction.

4. The household electric appliance operation system according to claim 1, further comprising:
a self-propelled electronic device; and
a communication terminal device for instructing, over a communication network, the self-propelled electronic device to operate,
wherein:
the operation signal transmitting section is included in the self-propelled electronic device; and
the display section and the instruction input section are included in the communication terminal device.

5. A self-propelled electronic device capable of transmitting, to a plurality of household electric appliances, an operation signal for controlling respective operations of the household electric appliances,
the self-propelled electronic device comprising:
a communication section for receiving, from another device over a communication network, operation signal information indicative of an operation signal for instructing a household electric appliance, selected by a user, to perform an operation corresponding to an operation content specified by the user;
an operation signal generating section for generating the operation signal on a basis of the operation signal information; and
an operation signal transmitting section for transmitting the operation signal generated by the operation signal generating section.

6. A layout information creating device for use (i) in an electronic device controlling system for instructing, over a communication network, a self-propelled electronic device to operate and (ii) to create layout information for a region in which the self-propelled electronic device is present,
the layout information including:
arrangement information indicative of a type and placement position of an object placed in the region; and
no-running area information for classifying the region into (i) a running area in which the self-propelled electronic device is able to run and (ii) a no-running area in which the self-propelled electronic device is unable to run,
the layout information creating device comprising:
a storage section storing, in association with each other, (i) an icon of the placed object and (ii) a no-running range in which the self-propelled electronic device is unable to run due to the placed object indicated by the icon; and
a control section for creating the layout information on a basis of (i) a placement position of an icon which placement position has been specified by a user and (ii) a no-running range stored in association the selected icon.

7. The layout information creating device according to claim 6,
wherein
the control section has a function of, in response to an instruction by the user, changing the no-running range stored in the storage section in association with the icon of the placed object.

8. The layout information creating device according to claim 6,
wherein
the control section has a function of, in response to an instruction by the user, toggling whether a range indicated in the no-running area information stored in the storage section belongs to a running area or a no-running area.

9. (canceled)

10. A self-propelled electronic device for (i) receiving, over a communication network, an operation instruction generated on a basis of layout information created by the layout information creating device according to claim 6 and (ii) operating on a basis of the operation instruction received.
